(19) United States
(12) Patent Application Publication
(10) Pub. No.: US 2017/0343346 A1
(43) Pub. Date: Nov. 30, 2017

(54) ULTRASONIC TILT SENSOR AND RELATED METHODS

(71) Applicant: QUALCOMM Incorporated, San Diego, CA (US)

(72) Inventors: Firas SAMMOURA, San Jose, CA (US); Stephanie FUNG, Davis, CA (US); Donald William KIDWELL, JR., Los Gatos, CA (US); Ravindra Vaman SHENOY, Dublin, CA (US); David William BURNS, San Jose, CA (US)

(21) Appl. No.: 15/169,503

(22) Filed: May 31, 2016

(51) Int. Cl. G01C 9/20; G01F 23/296

(52) U.S. Cl. CPC G01C 9/20; G01F 23/2965

(57) ABSTRACT

A device may include a surface at least partially defining an enclosed region, a plurality of fluids within the enclosed region, the plurality of fluids comprising at least a first fluid having a first acoustic impedance and a second fluid having a second acoustic impedance different from the first acoustic impedance, a first piezoelectric transducer disposed on the surface, the first piezoelectric transducer being configured to generate a first wave reception signal based, at least in part, on an ultrasonic return wave received through at least one of the plurality of fluids, and a processor coupled to the first piezoelectric transducer and configured to determine a measurement of a tilt of the device based, at least in part, on the first wave reception signal.

### INTRODUCTION

Aspects of this disclosure relate generally to orientation sensors, and more particularly to tilt sensors and inclinometers.

Position, heading, and/or orientation determination capability is increasingly utilized in a number of technological fields. A device that is equipped with a position sensor (for example, a Satellite Positioning System (SPS) or an Advanced Forward Link Trilateration (AFLT) system) may determine or record the position of the device. Similarly, a device that is equipped with one or more on-board inertial sensors (for example, accelerometers, gyroscopes, etc.) may measure an inertial state of the device. Inertial measurements obtained from these on-board inertial sensors may be used in combination with, or independent of, position determination to provide estimates of position, heading, and/or orientation (position, velocity, acceleration, orientation, etc.).

Devices may be further equipped with, for example, software applications that use position, heading, and/or orientation determinations to provide new or improved features and services to consumers. For example, smartphones, robots, automobiles, drones, and other devices can utilize improved position and motion determinations to enhance existing features and/or develop new features. However, new solutions are required for providing position, heading, and/or orientation determinations with low cost, high speed, reliable accuracy and/or fine precision.

### SUMMARY

The following summary is an overview provided solely to aid in the description of various aspects of the disclosure and is provided solely for illustration of the aspects and not limitations thereof.

In one example, a device is disclosed. The device may include, for example, a surface at least partially defining an enclosed region, a plurality of fluids within the enclosed region, the plurality of fluids comprising at least a first fluid having a first acoustic impedance and a second fluid having a second acoustic impedance different from the first acoustic impedance, a first piezoelectric transducer disposed on the surface, the first piezoelectric transducer being configured to generate a first wave reception signal based, at least in part, on an ultrasonic return wave received through at least one of the plurality of fluids, and a processor coupled to the first piezoelectric transducer and configured to determine a measurement of a tilt of the device based, at least in part, on the first wave reception signal.

In another example, a method is disclosed. The method may include, for example, generating, with a first piezoelectric transducer, a first wave reception signal based, at least in part, on an ultrasonic return wave received through at least one of a plurality of fluids, wherein the first piezoelectric transducer is disposed on a surface at least partially defining an enclosed region, the plurality of fluids are within the enclosed region, and the plurality of fluids comprise at least a first fluid having a first acoustic impedance and a second fluid having a second acoustic impedance different from the first acoustic impedance, and determining a measurement of a tilt of a device based, at least in part, on the first wave reception signal.

In yet another example, another device is disclosed. The device may include, for example, means for generating a first wave reception signal, being disposed on a surface at least partially defining an enclosed region, the first wave reception signal being based, at least in part, on an ultrasonic return wave received through at least one of a plurality of fluids, wherein the plurality of fluids are within the enclosed region, and the plurality of fluids comprise at least a first fluid having a first acoustic impedance and a second fluid having a second acoustic impedance different from the first acoustic impedance, and means for determining a measurement of a tilt of the device based, at least in part, on the first wave reception signal.

In yet another example, a non-transitory computer-readable medium comprising at least one instruction for causing a processor to perform operations is disclosed. The non-transitory computer-readable medium may include, for example, code for determining a measurement of a tilt of a device based, at least in part, on a first wave reception signal, the first wave reception signal being based, at least in part, on an ultrasonic return wave received through at least one of a plurality of fluids, and received from a first piezoelectric transducer disposed on a surface at least partially defining an enclosed region, wherein the plurality of fluids are within the enclosed region, and the plurality of fluids comprise at least a first fluid having a first acoustic impedance and a second fluid having a second acoustic impedance different from the first acoustic impedance.

### BRIEF DESCRIPTION OF THE DRAWINGS

The accompanying drawings are presented to aid in the description of various aspects of the disclosure and are provided solely for illustration of the aspects and not limitations thereof.

FIG. 1 illustrates a device having a conventional inertial motion unit.

FIG. 2A illustrates an ultrasonic tilt sensor in accordance with aspects of the disclosure, in a condition in which the ultrasonic tilt sensor is not tilted with respect to gravity.

FIG. 2B illustrates the ultrasonic tilt sensor of FIG. 2A in a condition in which the ultrasonic tilt sensor is tilted with respect to gravity in accordance with aspects of the disclosure.

FIG. 3 illustrates an ultrasonic tilt sensor in accordance with aspects of the disclosure.

FIG. 4 illustrates a device having position, heading, and/or orientation determination capabilities in accordance with aspects of the disclosure.

FIG. 5A illustrates an example of ultrasonic wave behavior within an untilted ultrasonic tilt sensor in accordance with aspects of the disclosure.

FIG. 5B illustrates an example of ultrasonic wave behavior within a tilted ultrasonic tilt sensor in accordance with aspects of the disclosure.

FIG. 6 illustrates a method of determining tilt based on a relative time of flight in an ultrasonic tilt sensor in accordance with aspects of the disclosure.

FIG. 7A illustrates an arrangement for determining tilt around a y-axis of an ultrasonic tilt sensor in accordance with the method of FIG. 6.

FIG. 7B illustrates an arrangement for determining tilt around an x-axis of an ultrasonic tilt sensor in accordance with the method of FIG. 6.

FIG. 7C illustrates an arrangement for determining tilt around the x-axis and the y-axis of an ultrasonic tilt sensor in accordance with the method of FIG. 6.

FIG. 7D illustrates an arrangement for determining tilt around the x-axis and the y-axis of an ultrasonic tilt sensor in accordance with the method of FIG. 6.

FIG. 8 illustrates a method of determining tilt based on an ultrasonic return wave reception pattern in accordance with aspects of the disclosure.

FIG. 9A illustrates an arrangement for determining tilt around the x-axis and the y-axis of an ultrasonic tilt sensor in accordance with the method of FIG. 8.

FIG. 9B illustrates the effect of tilting the ultrasonic tilt sensor of FIG. 9A around an x-axis in accordance with the method of FIG. 8.

FIG. 9C illustrates the effect of tilting the ultrasonic tilt sensor of FIG. 9A around a y-axis in accordance with the method of FIG. 8.

FIG. 9D illustrates the effect of tilting the ultrasonic tilt sensor of FIG. 9A around an x-axis and a y-axis in accordance with the method of FIG. 8.

FIG. 10 illustrates a method of determining tilt based on a position of a high-amplitude strike area in an ultrasonic tilt sensor in accordance with aspects of the disclosure.

FIG. 11A illustrates an ultrasonic tilt sensor configured to determine tilt in accordance with the method of FIG. 10.

FIG. 11B illustrates the effect of tilting the ultrasonic tilt sensor of FIG. 11A around an x-axis in accordance with the method of FIG. 10.

FIG. 11C illustrates the effect of tilting the ultrasonic tilt sensor of FIG. 11A around a y-axis in accordance with the method of FIG. 10.

FIG. 11D illustrates the effect of tilting the ultrasonic tilt sensor of FIG. 11A around an x-axis and a y-axis in accordance with the method of FIG. 10.

FIG. 12A illustrates an ultrasonic tilt sensor in accordance with aspects of the disclosure, in a condition in which the ultrasonic tilt sensor is not tilted with respect to gravity.

FIG. 12B illustrates the ultrasonic tilt sensor of FIG. 12A in a condition in which the ultrasonic tilt sensor is tilted with respect to gravity in accordance with aspects of the disclosure.

### DETAILED DESCRIPTION

The present disclosure relates generally to ultrasonic tilt sensors and related methods. According to certain aspects, an ultrasonic tilt sensor may include a surface having a plurality of piezoelectric transducers (PTs). The piezoelectric transducers may include, for example, piezoelectric micromachined ultrasonic transducers. One or more of the piezoelectric transducers may be configured to receive a piezoelectric transducer control signal and generate an ultrasonic transmission wave into an enclosed region that contains a first fluid and a second fluid having different acoustic impedances and densities. The ultrasonic transmission wave may be reflected off of a fluid interface between the first fluid and the second fluid, thereby generating an ultrasonic return wave. The ultrasonic return wave may be received by one or more of the piezoelectric transducers, which generate wave reception signals. As will be discussed in greater detail below, the tilt of the ultrasonic tilt sensor may be determined based on one or more of the following factors: (a) the relative positions of the piezoelectric transducers; (b) the piezoelectric transducer control signal characteristics of the piezoelectric transducer control signals received by the one or more piezoelectric transducers; and (c) the wave reception signal characteristics of the wave reception signals generated by the one or more piezoelectric transducers.

Various aspects of the disclosure are provided in the following description and related drawings directed to various examples provided for illustration purposes only. Alternate aspects may be devised without departing from the scope of the disclosure. Additionally, well-known aspects of the disclosure may not be described in detail or may be omitted so as not to obscure more relevant details.

Further, it will be appreciated that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

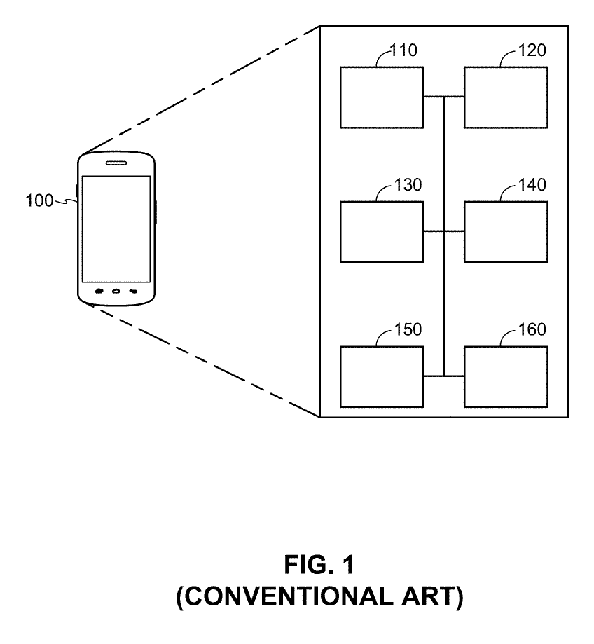

FIG. 1 illustrates a device 100 that includes conventional position, heading, and/or orientation determination capabilities. Although the device 100 is depicted as a smartphone, it will be understood that many types of devices have position, heading, and/or orientation determination capabilities (e.g., robots, automobiles, drones, etc.)

The device 100 includes a processor 110, a memory 120, a power unit 130, a user interface 140, a transceiver 150, and an inertial motion unit 160. The processor 110 executes instructions stored on the memory 120. The memory 120 may store other data that is generated by the processor 110, entered by a user of the device 100 via the user interface 140, received via the transceiver 150, or generated by the inertial motion unit 160. The power unit 130 may provide power to one or more components of the device 100. The transceiver 150 may send and receive one or more signals, enabling the device 100 to communicate with other devices. Signals received via the transceiver 150 may be used to determine a position, heading, and/or orientation of the device 100.

The inertial motion unit 160 may also generate one or more signals that are used to determine a position, heading, and/or orientation of the device 100. The position, heading, and/or orientation of the device 100 may be determined by the processor 110, stored in the memory 120, displayed to the user via the user interface 140, and/or transmitted via the transceiver 150. In some implementations, a software application stored in the memory 120 and executed by the processor 110 uses the position, heading, and/or orientation of the device 100 to provide features and services. The position, heading, and/or orientation of the device 100 may be determined using signals received via the transceiver 150, signals generated by the inertial motion unit 160, or a combination thereof.

In one example, the inertial motion unit 160 includes one or more microelectromechanical systems (MEMS) elements. Examples of MEMS elements are gyroscopes, accelerometers, and compasses. In one conventional arrangement, the tilt of the device 100 is determined using an inertial motion unit 160 having nine degrees of freedom (DOF). A nine-DOF inertial motion unit 160 conventionally includes three orthogonally-arranged gyroscopes, three orthogonally-arranged accelerometers, and three orthogonally-arranged compasses (e.g., magnetic field sensors). Determining the tilt of the device 100 based on the conventional nine-DOF inertial motion unit 160 can be computationally intensive, which increases the amount of time necessary to generate a tilt measurement and consumes the processing resources of the processor 110 and/or the power resources of the power unit 130. Moreover, the conventional nine-DOF inertial motion unit 160 may require frequent calibration.

The utility of software applications that rely on tilt information (particularly software applications with “always-on” functionality) may be reduced if tilt measurements consume a large amount of processing resources or power resources. The utility of software applications that rely on tilt information may be further reduced if tilt measurements are not generated with high speed, reliable accuracy, and/or fine precision.

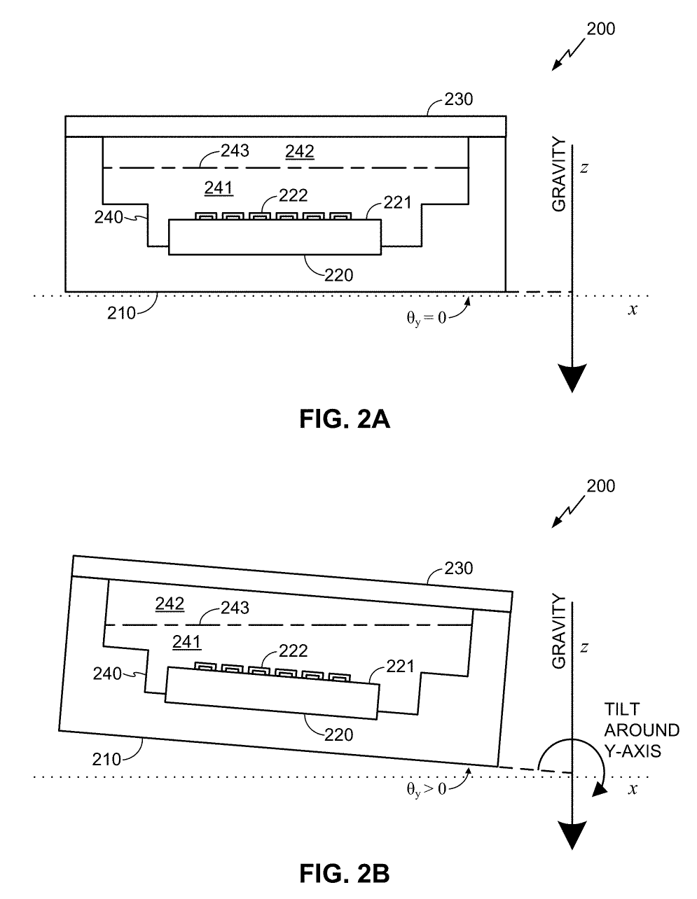

FIGS. 2A-2B illustrate a side view of an example of an ultrasonic tilt sensor 200 in accordance with aspects of the disclosure. FIG. 2A illustrates the ultrasonic tilt sensor 200 in a condition in which the ultrasonic tilt sensor 200 is not tilted with respect to gravity. FIG. 2B illustrates the ultrasonic tilt sensor 200 in a condition in which the ultrasonic tilt sensor 200 is tilted with respect to gravity.

The ultrasonic tilt sensor 200 depicted in FIGS. 2A-2B includes an integrated circuit package 210 that supports a sensor chip 220 having a surface 221. The surface 221 may be, for example, a planar surface, a curved surface, a multi-planar surface, or any other suitably-shaped surface. Piezoelectric transducers may be disposed on the surface 221. For example, the sensor chip 220 may comprise a planar substrate upon which the piezoelectric transducers are fabricated, embedded or mounted. Various piezoelectric transducers, sometimes referred to as piezoelectric micromachined ultrasonic transducers (PMUTs), may include a deformable diaphragm with one or more layers of piezoelectric material such as aluminum nitride (AlN) or lead zirconate titanate (PZT) and associated electrodes for making electrical contact to the piezoelectric layers. The deformable diaphragm is generally suspended over a glass or silicon substrate with a thin cavity region formed between the diaphragm and the substrate. The cavity region is generally filled with air or a vacuum and allows the diaphragm to deform and deflect when appropriate drive (e.g. excitation) voltages are applied to the piezoelectric layer, which can generate and transmit ultrasonic waves. In a receiving or sensing mode, the piezoelectric layers on the diaphragm may generate a piezoelectric output signal when the diaphragm is deformed, for example, with a reflected ultrasonic wave. The piezoelectric transducers in a piezoelectric transducer array may be selectively excited and sensed.

Although FIGS. 2A-2B depict a linear array of six equally-spaced piezoelectric transducers 222, it will be understood that other arrangements are possible. In some implementations, capacitive micromachined ultrasonic transducers (CMUTs) may be substituted for piezoelectric transducers. However, piezoelectric transducers may be preferable under some circumstances. CMUTs typically require an elevated DC bias voltage and can suffer from unintended pull-in or snap-in effects due to electrostatic attraction between the CMUT membrane and an underlying substrate that result in highly nonlinear or ineffective operation. By contrast, piezoelectric transducers may not require a DC bias voltage. The acoustic power generated by piezoelectric transducers may greatly exceed typical CMUT devices, resulting in higher output signals (e.g. wave reception signals) with lower amplitudes of applied drive signals (e.g., piezoelectric transducer control signals). The electromechanical coupling coefficients, that is, the efficiency of converting electrical energy to mechanical energy (and back again), are generally nonlinear for CMUTs compared to piezoelectric transducers. CMUTs may suffer from the collection of charges in associated dielectric layers due to the high bias voltage. Piezoelectric transducers generally have a piezoelectric layer positioned on or near a surface of the piezoelectric transducer membrane, which can generate large amounts of bending stress and deflect the piezoelectric transducer membrane to generate and launch ultrasonic waves without concern about the height of the gap between the piezoelectric transducer membrane and the underlying substrate.

The ultrasonic tilt sensor 200 may further include a cover 230 that is fitted to the integrated circuit package 210. As a result, an enclosed region 240 may be formed within the ultrasonic tilt sensor 200. The outer bounds of the enclosed region 240 may be defined by one or more of the integrated circuit package 210, the sensor chip 220, the surface 221, the piezoelectric transducers 222, the cover 230, or any combination thereof. The enclosed region 240 may be filled or partially filled with a first fluid 241 and a second fluid 242.

The first fluid 241 may have a first acoustic impedance and the second fluid 242 may have a second acoustic impedance different from the first acoustic impedance. The first fluid 241 may also have a first mass density and the second fluid 242 may have a second mass density different from the first mass density. The first fluid 241 may be a liquid or gas (for example, water, oil, glycerin, ethylene glycol, air, nitrogen, argon, etc.). The second fluid 242 may also be liquid or gas, but may be a different liquid or gas than the first fluid 241. Alternatively, the first fluid 241 and the second fluid 242 may be the same substance, but the first fluid 241 may be in gas form and the second fluid 242 may be in liquid form (or vice-versa). A fluid interface 243 may exist between the first fluid 241 and the second fluid 242. The fluid interface 243 is depicted in FIGS. 2A-2B as a line with alternating long and short dashes.

Gravity is depicted in FIGS. 2A-2B as a downward arrow. As used herein, a z-axis is arbitrarily defined as being parallel with the direction of the gravitational force. As used herein, an x-axis and a y-axis are arbitrarily defined as being within or parallel to a plane that is perpendicular to the direction of gravity. In FIGS. 2A-2B, the x-axis extends left and right and is depicted as a dotted line. The y-axis, which is perpendicular to both the x-axis and the z-axis, is not depicted.

The tilt θ of the ultrasonic tilt sensor 200 may be defined as an angular difference between some predetermined plane associated with the ultrasonic tilt sensor 200 and a plane that is perpendicular to the direction of gravity (depicted in FIGS. 2A-2B as a dotted line, as noted above). As an example, the tilt θ of the ultrasonic tilt sensor 200 may be defined as an angular difference between the surface 221 (upon which the piezoelectric transducers 222 are disposed) and a plane that is perpendicular to the direction of gravity. It will be understood that the tilt θ may have an x-component θ, and a y-component θ_{y}.

As noted above, FIG. 2A illustrates the ultrasonic tilt sensor 200 in an untilted state with respect to gravity. Accordingly, the angle θ_{y} as depicted in FIG. 2A is equal to zero. By contrast, FIG. 2B shows the ultrasonic tilt sensor 200 in a condition in which it is rotated about the y-axis, and therefore tilted with respect to gravity. Accordingly, the angle θ_{y} as depicted in FIG. 2B is greater than zero.

As the ultrasonic tilt sensor 200 tilts, the first fluid 241 may flow in the direction of gravity and displace the second fluid 242. Accordingly, the fluid interface 243 between first fluid 241 and the second fluid 242 remains perpendicular to the direction of gravity. As can be appreciated from FIGS. 2A-2B, as the ultrasonic tilt sensor 200 rotates clockwise around the y-axis, the fluid interface 243 gets closer to the piezoelectric transducer 222 that is furthest left on the x-axis, and the fluid interface 243 gets further from the piezoelectric transducer 222 that is furthest right on the x-axis. It will be understood that if the ultrasonic tilt sensor 200 were rotated counterclockwise around the y-axis, the opposite would occur.

When the piezoelectric transducer 222 receives a piezoelectric transducer control signal, the piezoelectric transducer 222 generates an ultrasonic transmission wave that travels through the first fluid 241 and strikes the fluid interface 243. The application of the piezoelectric transducer control signal to the piezoelectric transducer 222 may be referred to herein as a “firing” of the piezoelectric transducer 222. When the piezoelectric transducer 222 is fired, it generates an ultrasonic transmission wave having one or more signal characteristics that are similar or partially similar to the signal characteristics of the received piezoelectric transducer control signal.

After the piezoelectric transducer 222 is fired, an ultrasonic transmission wave is generated within the enclosed region 240. Because the first fluid 241 and the second fluid 242 have different acoustic impedances, at least a portion of the ultrasonic transmission wave may be reflected off of the fluid interface 243, thereby generating an ultrasonic return wave. The ultrasonic return wave may then travel through the first fluid 241 and strike one or more of the piezoelectric transducers 222. When the ultrasonic return wave strikes the piezoelectric transducer 222, it generates a wave reception signal. The wave reception signal may have one or more signal characteristics that are similar or partially similar to the signal characteristics of the received ultrasonic return wave.

The tilt of the ultrasonic tilt sensor 200 can subsequently be determined based on one or more of the following factors: (a) the relative positions of one or more of the piezoelectric transducers 222; (b) the piezoelectric transducer control signal characteristics of the piezoelectric transducer control signals received by one or more of the piezoelectric transducers 222; and (c) the wave reception signal characteristics of the wave reception signals generated by one or more of the piezoelectric transducers 222.

In some implementations, the sensor chip 220 may have temperature detection functionality. Wave behavior within the first fluid 241 and/or the second fluid 242 may depend on a temperature of the first fluid 241 and the second fluid 242. Accordingly, a temperature reading generated by the sensor chip 220 may be used to facilitate accurate tilt determinations. For example, in some implementations, the tilt may be determined based on (among other factors) the speed of sound in the first fluid 241. Because the speed of sound in the first fluid 241 may change as temperatures change, the sensor chip 220 may have temperature detection functionality in order to facilitate tilt determinations.

In some implementations, the cover 230 may include one or more layers of plastic, glass, metal, ceramic or other suitable cover material. In some implementations, the cover 230 may be formed from a portion of a cover glass or cover lens of a display device, or from a portion of an enclosure of a mobile device. In some implementations, a portion of the cover 230 facing the enclosed region 240 may be substantially flat as shown in FIG. 2. In some implementations, the cover 230 may have a hemispherical or otherwise rounded region on an inside surface that provides first fluid 241, second fluid 242 and the fluid interface 243 more room to rotate as the ultrasonic tilt sensor 200 is rotated, increasing the usable range of the tilt sensor. Analyzing the fluid line of the fluid interface 243 as the fluid line traverses the array of piezoelectric transducers 222 with large tilt angles may increase the usable range. In some implementations, more than one sensor chip 220 having a surface 221 and an array of piezoelectric transducers 222 disposed thereon may be positioned inside the tilt sensor 200, such as on one or more sidewalls of the package 210 or on the inside of the cover 230, to allow three-dimensional or three-axis tilt sensing and/or to increase the usable range. In some implementations, the enclosed region 240 may include one or more baffles (not shown) or other features to slow or otherwise control fluid flow within the tilt sensor 200. The first fluid 241 and/or the second fluid 242 may include components that increase the boiling point or decrease the freezing point such as one or more solutes. In some implementations, the first fluid 241 and/or the second fluid 242 may include components that increase or decrease the fluid viscosity, modify the fluidic damping, alter the speed of sound, or control the shape of the meniscus between the fluid interface 243 and sidewalls of the enclosed region 240.

In operation, a calibration sequence or a process may be executed to determine the distance from the array of piezoelectric transducers 222 to the fluid interface 243, such as a time-of-flight measurement. The calibration sequence may aid in determining whether the tilt sensor 200 is right-side up or upside down, in part by determining the speed of sound of the specific fluid in contact with the piezoelectric transducers 222, by observing whether a phase inversion occurs in the ultrasonic return wave (an in-phase reflection will occur if the acoustic impedance of the fluid furthest from the piezoelectric transducers 222 is higher than the fluid closest to the piezoelectric transducers 222, whereas an out-of-phase reflection will occur if the acoustic impedance of the fluid furthest from the piezoelectric transducers 222 is lower than the fluid closest to the piezoelectric transducers 222), or by determining the distance to the fluid interface 243 (which may be asymmetric if the relative volumes of the first fluid 241 and the second fluid 242 are asymmetric). The calibration sequence may aid in determining an optimal frequency of operation, such as the frequency of applied piezoelectric transducer control signals to drive/excite the piezoelectric transducers 222. In some implementations, package 210 may constitute a wafer-level-package (WLP).

During manufacturing, a plurality of sensor chips 220 may be formed simultaneously on a common substrate such as a silicon wafer or a glass or plastic panel. A companion wafer or panel with a plurality of covers 230 may be mated with the sensor chips 220 prior to singulation (e.g. by dicing or sawing). First fluid 241 and second fluid 242 may be injected through a seal hole (not shown) into the enclosed region 240 of each ultrasonic tilt sensor 200 and the seal holes of the package 210 may be sealed prior to or after singulation.

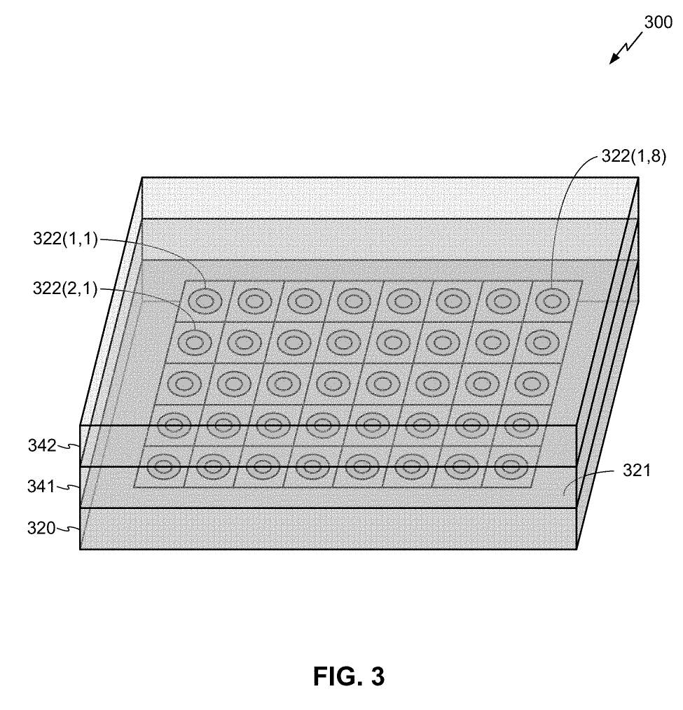

FIG. 3 illustrates an ultrasonic tilt sensor 300 in accordance with aspects of the disclosure. The ultrasonic tilt sensor 300 of FIG. 3 may have a number of components that are analogous to the components of the ultrasonic tilt sensor 200 of FIGS. 2A-2B. For example, the ultrasonic tilt sensor 300 includes a sensor chip 320 having a surface 321 that may be similar to the sensor chip 220 and the surface 221 of FIGS. 2A-2B. FIG. 3 also depicts a first fluid 341 and a second fluid 342 that may be analogous to the first fluid 241 and the second fluid 242 of FIGS. 2A-2B.

The ultrasonic tilt sensor 300 of FIG. 3 includes an array of piezoelectric transducers 322 arranged on the surface 321 of the sensor chip 320. Unlike the ultrasonic tilt sensor 200, which depicts a linear array of piezoelectric transducers 222, the ultrasonic tilt sensor 300 of FIG. 3 includes an array of piezoelectric transducers 322. The piezoelectric transducers 322 may be arranged in rows and columns. For example, a row of piezoelectric transducers 322 may be arranged along an x-axis of the surface 321, and a column of piezoelectric transducers 322 may be arranged along a y-axis of the surface 321. Although FIG. 3 depicts five rows and eight columns, it will be understood that other arrangements are possible. Because the ultrasonic tilt sensor 300 of FIG. 3 includes rows of piezoelectric transducers 322 arranged along the x-axis and columns of piezoelectric transducers 322 arranged along the y-axis, the ultrasonic tilt sensor 300 can measure both an x-component of tilt θₓ and a y-component of tilt θ_{y}.

In FIG. 3, three individual piezoelectric transducers 322 are labeled in accordance with their respective addresses within the piezoelectric transducer array (x, y). Accordingly, the piezoelectric transducer 322 in the first row and the first column is labeled as piezoelectric transducer 322(1, 1), the piezoelectric transducer 322 in the second row and the first column is labeled as piezoelectric transducer 322(2, 1), and the piezoelectric transducer 322 in the first row and the eighth column is labeled as piezoelectric transducer 322(1, 8).

The individual piezoelectric transducers 322 may be separately addressable. As used herein, an individual piezoelectric transducer 322 that is “separately addressable” (for example, piezoelectric transducer 322(1, 1)) may be configured to fire independently of the remaining piezoelectric transducers 322 in the piezoelectric transducer array (for example, piezoelectric transducer 322(2, 1), piezoelectric transducer 322(1, 8), etc.). Additionally or alternatively, an individual piezoelectric transducer 322 that is separately addressable may be configured to generate a wave reception signal that may be read out independently from wave reception signals generated by other piezoelectric transducers 322 in the array.

In some implementations, individual piezoelectric transducers 322 may not be separately addressable. For example, in some configurations, a single piezoelectric transducer control signal may be commonly applied to every piezoelectric transducer 322 in the array. In other implementations, subsets of individual piezoelectric transducers 322 may be separately addressable, for example, a specific row of piezoelectric transducers 322, a specific column of piezoelectric transducers 322, a central grouping of piezoelectric transducers 322, etc.

In some implementations, the ultrasonic tilt sensor 300 may be capable of reading out an average wave reception signal received across a specific row in the piezoelectric transducer array, a specific column in the piezoelectric transducer array, portions of rows or columns in the piezoelectric transducer array, a subarray of the piezoelectric transducers 322, or the entirety of the piezoelectric transducer array.

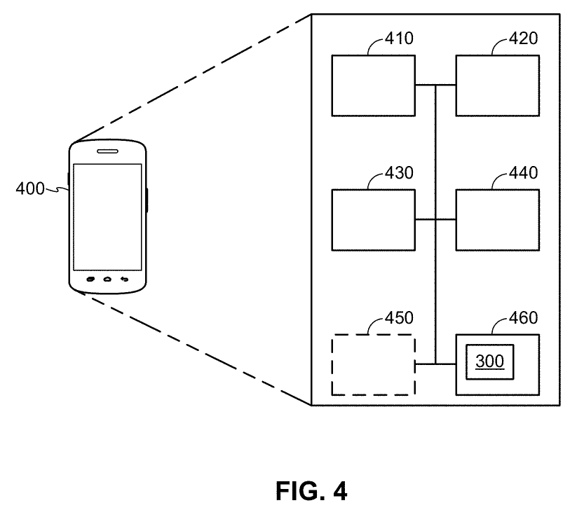

FIG. 4 illustrates a device 400 that includes position, heading, and/or orientation determination capabilities in accordance with aspects of the disclosure.

Although the device 400 is depicted as a smartphone, it will be understood that many devices have position, heading, and/or orientation determination capabilities. For example, robots, automobiles, drones, and other devices may use position, heading, and/or orientation determinations to provide new or improved features and services to consumers. As will be discussed in greater detail below, the device 400 of FIG. 4, depicted as a smartphone, may incorporate an ultrasonic tilt sensor analogous to the ultrasonic tilt sensor 200 depicted in FIGS. 2A-2B and/or the ultrasonic tilt sensor 300 depicted in FIG. 3. However, the ultrasonic tilt sensors and related methods of the present disclosure are not limited to smartphones. The ultrasonic tilt sensors of the present disclosure may be incorporated into a robot, an automobile, a drone, or any other device that determines position, heading, and/or orientation.

The device 400 may include a number of components that are analogous in some respects to the components of the device 100 depicted in FIG. 1. For example, the device 400 may include a processor 410, a memory 420, a power unit 430, a user interface 440, and an optional transceiver 450. The processor 410 may execute instructions stored on the memory 420. The memory 420 may store data that is generated by the processor 410, entered by a user of the device 400 via the user interface 440, or received via the optional transceiver 450. The power unit 430 may provide power to one or more components of the device 400. The optional transceiver 450 may send and receive one or more signals, enabling the device 400 to communicate with other devices. Signals received via the optional transceiver 450 may be used to determine a position, heading, and/or orientation of the device 400.

The device 400 further includes a motion unit 460. Like the inertial motion unit 160, the motion unit 460 may generate one or more signals that are used to determine a position, heading, and/or orientation of the device 400. The position, heading, and/or orientation of the device 400 may be determined by the processor 410 based on signals received via the optional transceiver 450, signals generated by the motion unit 460, or a combination thereof. The motion unit 460 may optionally include one or more inertial motion sensors similar to the gyroscopes, accelerometers, and/or compasses included in the inertial motion unit 160 of FIG. 1.

Unlike the inertial motion unit 160 depicted in FIG. 1, the motion unit 460 further includes an ultrasonic tilt sensor as described in the present application. Although the ultrasonic tilt sensor 300 is depicted in FIG. 4, it will be understood that the motion unit 460 may include any number of ultrasonic tilt sensors, respectively analogous to the ultrasonic tilt sensor 200 depicted in FIGS. 2A-2B, the ultrasonic tilt sensor 300 depicted in FIG. 3, or any other ultrasonic tilt sensor set forth in the present application.

Like the device 100, the device 400 can use signals received at the optional transceiver 450 and/or signals generated by inertial motion sensors within the motion unit 460 to determine the position, heading, and/or orientation of the device 400. However, the signals generated by the ultrasonic tilt sensor 300 may be used to calibrate, supplement, or supplant these determinations. For example, the device 400 may determine that the inertial motion sensors within the motion unit 460 are miscalibrated and subsequently activate a calibration process based on signals generated by the ultrasonic tilt sensor 300. As another example, the device 400 may determine position and heading based on signals received from the optional transceiver 450 and may determine orientation based on signals generated by the ultrasonic tilt sensor 300. As another example, the device 400 may not include the optional transceiver 450 and the motion unit 460 may not include any inertial motion sensors, in which case the position, heading, and/or orientation of the device 400 are determined on the basis of signals generated by one or more ultrasonic tilt sensors 300. It will be understood that other arrangements are possible. After determining the position, heading, and/or orientation of the device 400, the processor 410 may store the determination in the memory 420, display the determination to the user via the user interface 440, and/or transmit the determination via the optional transceiver 450. In some implementations, a software application stored in the memory 420 and executed by the processor 410 may use the position, heading, and/or orientation of the device 400 to provide new or improved features and services. For example, one or more tilt sensors 300 may be used to determine the angle of inclination of a sitting robot prior to standing or a stationary drone prior to liftoff. The inclination angles may be used to calibrate or null accelerometers and other sensors in the motion unit 460. Alternatively, accelerometers within the motion unit 460 may be used to determine when the tilt sensor 300 is within a target range (e.g. +/−10 degrees), and measurements from the tilt sensor taken to refine the orientation determination.

The processor 410 and/or the memory 420 depicted in FIG. 4 may be configured to perform various functions based on the signals received from the ultrasonic tilt sensor 300. As noted above, the tilt of the ultrasonic tilt sensor 300 may be determined based on one or more of the following factors: (a) the relative positions of one or more of the piezoelectric transducers 322; (b) the piezoelectric transducer control signal characteristics of the piezoelectric transducer control signals received by one or more of the piezoelectric transducers 322; and (c) the wave reception signal characteristics of the wave reception signals generated by one or more of the piezoelectric transducers 322.

Accordingly, the processor 410 and/or the memory 420 may be configured to determine and or store the positions and/or addresses of the piezoelectric transducers 322 and determine positions of the piezoelectric transducers 322 relative to another piezoelectric transducer 322, a subset of piezoelectric transducers 322, or a geometric feature thereof.

Additionally or alternatively, the processor 410 and/or memory 420 may be configured to generate a piezoelectric transducer control signal and select the particular piezoelectric transducer control signal characteristics of the piezoelectric transducer control signal. If the ultrasonic tilt sensor 300 has multiple separately-addressable piezoelectric transducers 322 (or subsets thereof), then the processor 410 and/or the memory 420 may be configured to generate and/or store individual piezoelectric transducer control signals for each of the multiple separately-addressable piezoelectric transducers 322 (or subsets thereof) and send the respective piezoelectric transducer control signals to each of the multiple separately-addressable piezoelectric transducers 322 (or subsets thereof).

Additionally or alternatively, the processor 410 and/or the memory 420 may be configured to receive a wave reception signal from one or more of the piezoelectric transducers 322 and determine particular wave reception signal characteristics of the wave reception signal. If the ultrasonic tilt sensor 300 has multiple separately-addressable piezoelectric transducers 322, then the processor 410 and/or the memory 420 may be configured to receive and/or store individual wave reception signals from each of the multiple separately-addressable piezoelectric transducers 322 and determine the respective addresses of each piezoelectric transducer 322 from which an individual wave reception signal was received.

In some implementations, the processor 410 and/or the memory 420 may be configured to process the received wave reception signals. For example, the processor 410 and/or the memory 420 may be configured to determine an average wave reception signal received from the piezoelectric transducer 322 array, an average wave reception signal of an individual row or column of piezoelectric transducers 322, or an average wave reception signal of an arbitrarily-defined subset of piezoelectric transducers 322. Additionally or alternatively, the sensor chip 320 may be configured to perform the processing of the wave reception signal (or a portion of the processing).

In some implementations, the processor 410 and/or the memory 420 may be further configured to control the transmission and reception timing of one or more of the piezoelectric transducers 322. For example, the processor 410 and/or the memory 420 may set a transmission start time of the piezoelectric transducer control signal such that transmission of the ultrasonic transmission wave begins at a wave start time selected by the processor 410 and/or the memory 420. The processor 410 and/or the memory 420 may also be configured to set a transmission end time of the piezoelectric transducer control signal such that transmission of the ultrasonic transmission wave ends at a wave end time selected by the processor 410 and/or the memory 420. Moreover, the processor 410 and/or the memory 420 may be configured to set a reception start time at which one or more of the piezoelectric transducers 322 begins the conversion of the received ultrasonic return wave into the wave reception signal and a reception end time at which the one or more piezoelectric transducers 322 terminates generation of the wave reception signal. The duration of time between the transmission start time of the piezoelectric transducer control signal and the reception start time of the wave reception signal may be referred to as a range-gate delay (RGD). The duration of time that follows the RGD, between the reception start time of the wave reception signal and the reception end time of the wave reception signal, may be referred to as a range-gate window (RGW). During the RGW (also referred to as the range-gate width), the wave reception signal may be acquired. In some implementations, one or more wave reception signals may be acquired during the range-gate window. The wave reception signal acquisition may be acquired during the RGW, that is, the wave reception signals may be acquired during the time that the RGW is open until the time that the RGW is closed. As will be described in greater detail below, the processor 410 and/or the memory 420 may select the signal characteristics of the piezoelectric transducer control signal (including the transmission start time and transmission end time, as noted above) as well as the RGD and RGW of the wave reception signal. Control of the RGD and RGW may be performed by instructing the piezoelectric transducers 322 to start and end generation of the wave reception signal. Additionally or alternatively, the processor 410 and/or the memory 420 may simply truncate the wave reception signal received from the piezoelectric transducers 322 in accordance with the selected RGD and RGW. In some implementations, a peak detector circuit may be associated with each of the piezoelectric transducers 322, and the peak detector circuit may capture or otherwise acquire a peak wave reception signal during and within the bounds of the RGW.

The sensor chip 320 or some other component of the ultrasonic tilt sensor 300 may have temperature detection functionality (similar to the sensor chip 220, as noted above). The processor 410 and/or the memory 420 may be further configured to receive temperature data from the sensor chip 320 (or other component) and determine tilt based at least in part on the temperature data.

For the sake of simplicity, the various features and functions illustrated in FIG. 4 are connected together using a common bus which is meant to represent that these various features and functions are operatively coupled together. Those skilled in the art will recognize that other connections, mechanisms, features, functions, or the like, may be provided and adapted as necessary to operatively couple and configure the components of the device 400. Further, it is also recognized that one or more of the features or functions illustrated in the example of FIG. 4 may be further subdivided or two or more of the features or functions illustrated in FIG. 4 may be combined.

The optional transceiver 450 may be configured to operate in accordance with one or more communications protocols, for example, Wireless Local Area Network (WLAN) technologies (most notably IEEE 802.11 WLAN technologies generally referred to as “Wi-Fi”), Wide Area Network (WAN) technologies (for example, Code Division Multiple Access (CDMA), Time Division Multiple Access (TDMA), Frequency Division Multiple Access (FDMA), Orthogonal Frequency Division Multiple Access (OFDMA), etc.), Satellite Positioning System (SPS) technologies (for example, Global Positioning System (GPS) and/or a Global Navigation Satellite System (GNSS)), short range wireless technologies (for example, Bluetooth), etc. In some implementations, the optional transceiver 450 is constituted by a plurality of transceivers configured to operate in accordance with different communications protocols. In yet other implementations, the optional transceiver 450 is omitted altogether.

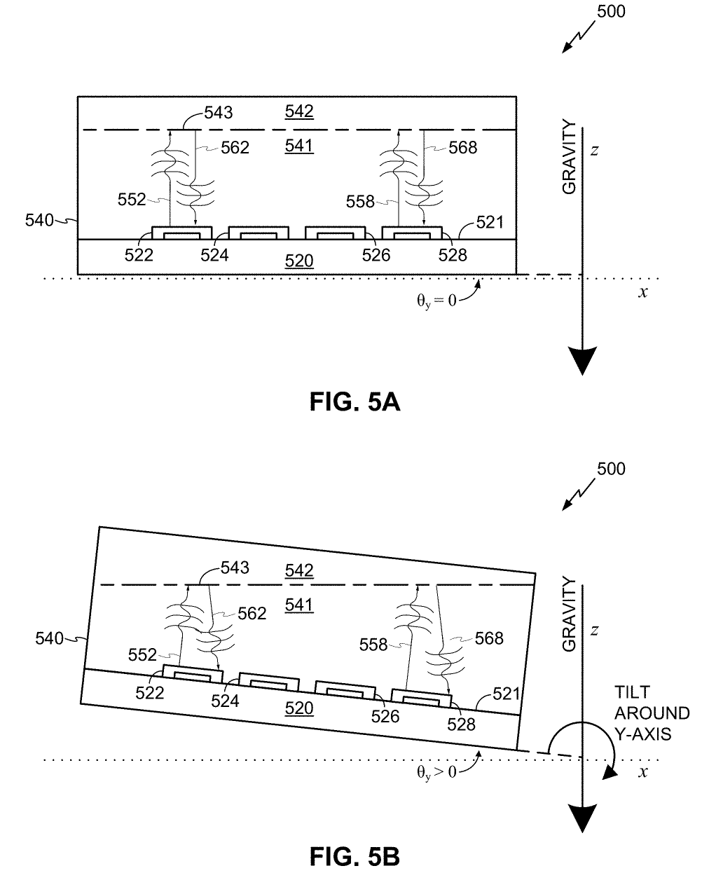

FIGS. 5A-5B illustrate examples of ultrasonic wave behavior within an ultrasonic tilt sensor 500 that is analogous to the ultrasonic tilt sensor 200 and/or ultrasonic tilt sensor 300 depicted in FIGS. 2A-2B and/or FIG. 3. The ultrasonic tilt sensor 500 includes a sensor chip 520 (analogous to the sensor chip 220 and the sensor chip 320 described above), an enclosed region 540 (analogous to the enclosed region 240 described above), a first fluid 541 (analogous to the first fluid 241 and first fluid 341 described above), and a second fluid 542 (analogous to the second fluid 242 and second fluid 342 described above). Moreover, an x-axis is shown as a dotted line running left to right and the force due to gravity is shown as a downward arrow arranged on a z-axis. A tilt around the y-axis θ_{y} is zero in FIG. 5A and greater than zero in FIG. 5B. The ultrasonic tilt sensor 500 depicts a linear arrangement of four equally-spaced piezoelectric transducers (522, 524, 526, and 528) running parallel to the x-axis. The ultrasonic tilt sensor 500 may further include additional components analogous to, for example, the integrated circuit package 210 and the cover 230 depicted in FIGS. 2A-2B, but for clarity of illustration, these elements are omitted from FIGS. 5A-5B.

FIGS. 5A-5B depict an ultrasonic transmission wave 552 that is transmitted into the first fluid 541 from a first piezoelectric transducer 522 and an ultrasonic transmission wave 558 that is transmitted into the first fluid 541 from a second piezoelectric transducer 528. As discussed elsewhere in the present application, the ultrasonic transmission wave 552 and ultrasonic transmission wave 558 may be caused by piezoelectric transducer control signals that are applied to the first piezoelectric transducer 522 and second piezoelectric transducer 528 by a processor and/or a memory analogous to the processor 410 and/or the memory 420 depicted in FIG. 4. The respective piezoelectric transducer control signals may have specific piezoelectric transducer control signal characteristics, for example, timing, amplitude, frequency, phase, pulse width, etc. The piezoelectric transducers 524, 526 may also transmit ultrasonic transmission waves, but for clarity of illustration, these are not depicted in FIGS. 5A-5B. In some implementations, the respective piezoelectric transducer control signals applied to a plurality of piezoelectric transducers (for example, 522, 524, 526 and 528) may have identical piezoelectric transducer control signal characteristics. In other implementations, the piezoelectric transducer control signals respectively applied to the plurality of piezoelectric transducers (for example, 522, 524, 526 and 528) may have different piezoelectric transducer control signal characteristics.

FIGS. 5A-5B further depict an ultrasonic return wave 562 and an ultrasonic return wave 568. The ultrasonic return wave 562 is a reflection of the ultrasonic transmission wave 552 and the ultrasonic return wave 568 is a reflection of the ultrasonic transmission wave 558. Both the ultrasonic return wave 562 and the ultrasonic return wave 568 are reflected off of the fluid interface 543 between the first fluid 541 and the second fluid 542 before being received at the sensor chip 520.

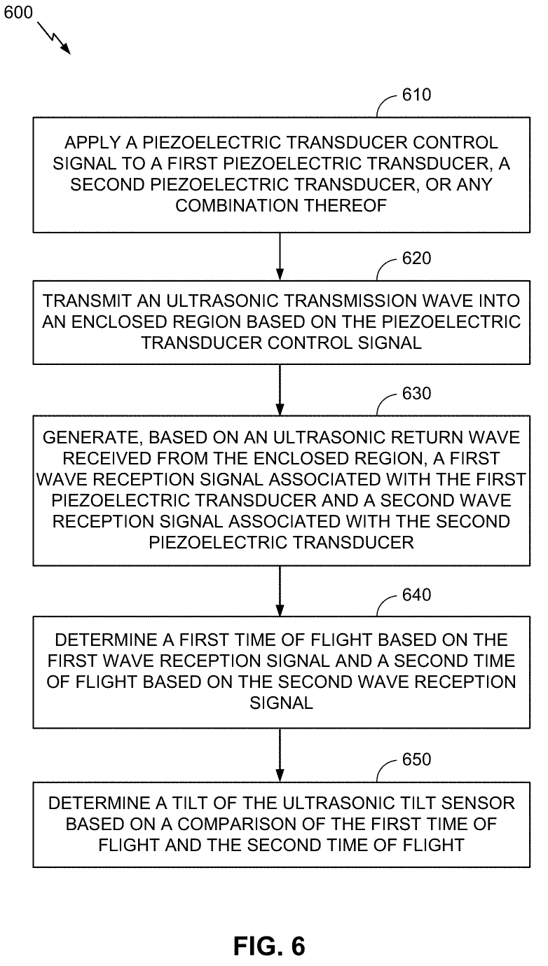

FIG. 6 illustrates a method 600 of determining tilt based on a relative time of flight in an ultrasonic tilt sensor having a plurality of piezoelectric transducers. For purposes of illustration, the method 600 will be described as it would be performed by the device 400 depicted in FIG. 4. Moreover, the device 400 will be assumed to incorporate the ultrasonic tilt sensor 500 depicted in FIGS. 5A-5B.

At 610, the device 400 applies a piezoelectric transducer control signal to a first piezoelectric transducer 522, a second piezoelectric transducer 528, or any combination thereof. The applying at 610 may be performed, for example, by the processor 410 and/or the memory 420 via one or more electrical traces and interconnections. In some implementations, the piezoelectric transducer control signal is a first piezoelectric control signal that is applied to the first piezoelectric transducer 522, and the device 400 further applies a second piezoelectric transducer control signal to the second piezoelectric transducer 528. The first piezoelectric transducer control signal and the second piezoelectric transducer control signal may have respective piezoelectric transducer control signal characteristics that are selected by the processor 410 and/or the memory 420. In some implementations, the signal characteristics of the second piezoelectric transducer control signal may differ from the signal characteristics of the first piezoelectric transducer control signal.

At 620, the device 400 transmits an ultrasonic transmission wave into an enclosed region based on the piezoelectric transducer control signal. The transmitting at 620 of the ultrasonic transmission wave may be performed, for example, by the first piezoelectric transducer 522, the second piezoelectric transducer 528, or any combination thereof. Accordingly, the ultrasonic transmission wave may include a first ultrasonic transmission wave 552 transmitted by the first piezoelectric transducer 522 and a second ultrasonic transmission wave 558 transmitted by the second piezoelectric transducer 528. The first ultrasonic transmission wave 552 and the second ultrasonic transmission wave 558 may be transmitted in an enclosed region that includes the first fluid 541 and the second fluid 542. As discussed previously, at least a portion of the first ultrasonic transmission wave 552 and the second ultrasonic transmission wave 558 may be reflected by a fluid interface 543 between the first fluid 541 and the second fluid 542. Moreover, the first ultrasonic transmission wave 552 and the second ultrasonic transmission wave 558 may be reflected as the first ultrasonic return wave 562 and the second ultrasonic return wave 568, respectively.

At 630, the device 400 generates, based on an ultrasonic return wave received from the enclosed region, a first wave reception signal associated with the first piezoelectric transducer 522 and a second wave reception signal associated with the second piezoelectric transducer 528. The receiving at 630 of the first ultrasonic return wave 562 and the second ultrasonic return wave 568 and the generation of the first wave reception signal and the second wave reception signal may be performed, for example, by the first piezoelectric transducer 522 and the second piezoelectric transducer 528, respectively. In some implementations, the receiving and the generation at 630 may be performed during the RGW selected by the processor 410 and/or the memory 420. As discussed previously, the first wave reception signal and the second wave reception signal may be caused by ultrasonic waves analogous to the first ultrasonic return wave 562 and the second ultrasonic return wave 568.

At 640, the device 400 determines a first time of flight based on the first wave reception signal and determines a second time of flight based on the second wave reception signal. The determining at 640 may be performed, for example, by the processor 410 and/or the memory 420.

As an example, the processor 410 and/or the memory 420 may select a firing time of the first piezoelectric transducer 522 and the second piezoelectric transducer 528, respectively. For example, the first piezoelectric transducer control signal may cause the first piezoelectric transducer 522 to transmit the ultrasonic transmission wave 552 at a first selected firing time and the second piezoelectric transducer control signal may cause the second piezoelectric transducer 528 to transmit the ultrasonic transmission wave 558 at a second selected firing time.

Moreover, the first piezoelectric transducer 522 and the second piezoelectric transducer 528 may be separately addressable such that the processor 410 and/or the memory 420 receive a first wave reception signal associated with the first piezoelectric transducer 522 and a second wave reception signal associated with the second piezoelectric transducer 528.

The processor 410 and/or the memory 420 may process the first wave reception signal to determine a first reception time that indicates the time at which the first wave reception signal reaches a threshold value. Moreover, the processor 410 and/or the memory 420 may process the second wave reception signal to determine a second reception time that indicates the time at which the second wave reception signal reaches a threshold value. The threshold values may be set to coincide with the minimum signal level of a wave reception signal that indicates a leading portion of an ultrasonic return wave has been received from the interface between the first fluid and the second fluid.

The processor 410 and/or the memory 420 may then determine a first time of flight equal to the difference between the first selected firing time and the first reception time. Moreover, the processor 410 and/or the memory 420 may determine a second time of flight equal to the difference between the second selected firing time and the second reception time.

In some implementations, the first piezoelectric transducer 522 and the second piezoelectric transducer 528 may be fired simultaneously, such that the first selected firing time is equal to the second selected firing time. Additionally or alternatively, the first piezoelectric transducer control signal and the second piezoelectric transducer control signal may have other shared signal characteristics, for example, amplitude, frequency, phase, firing duration, number of cycles, etc. In some implementations, the processor 410 and/or the memory 420 applies a single piezoelectric transducer control signal to a common input of both the first piezoelectric transducer 522 and the second piezoelectric transducer 528, such that the first piezoelectric transducer control signal and the second piezoelectric transducer control signal are identical.

At 650, the device 400 determines a tilt of the ultrasonic tilt sensor 500 based on a comparison of the first time of flight and the second time of flight. The determining at 650 may be performed, for example, by the processor 410 and/or the memory 420. The determining at 650 may also be based on a known distance between the first piezoelectric transducer 522 and the second piezoelectric transducer 528. The known distance may be, for example, stored in the memory 420 and/or determined based on array data stored in the memory 420.

In some implementations, the processor 410 and/or the memory 420 may use a look-up table stored in the memory 420 to determine the amount of tilt indicated by the result of the comparison. In other implementations, the processor 410 and/or the memory 420 may use an algorithm to determine the amount of tilt indicated by the result of the comparison.

In one example, the algorithm used to determine the tilt at 650 determines that the tilt θ is equal to arctan((TOF₂−TOF₁)*vₛ/L), where θ is the tilt, TOF₁ and TOF₂ are the first time of flight and the second time of flight, respectively, vₛ is the speed of sound in the first fluid 541, and L is the distance between the first piezoelectric transducer 522 and the second piezoelectric transducer 528. In some implementations, the vₛ may be a constant based on an assumption that the first fluid 541 is at a particular temperature (for example, room temperature). In other implementations, vₛ may be determined based on a temperature of the device 400. For example, the sensor chip 520 may be configured to measure the temperature of the first fluid 541.

The correlation between times of flight and tilt will be further described with reference to FIGS. 5A-5B. In the untilted state of FIG. 5A, the ultrasonic transmission wave 552 transmitted by the first piezoelectric transducer 522 travels a certain distance through the first fluid 541 prior to being reflected by the fluid interface 543 between the first fluid 541 and the second fluid 542. After being reflected in the opposite direction, the ultrasonic return wave 562 travels the same distance back toward the first piezoelectric transducer 522. The first time of flight associated with the first piezoelectric transducer 522 is equal to the amount of time it takes for the ultrasonic transmission wave 552 to travel from the first piezoelectric transducer 522 to the fluid interface 543 plus the amount of time it takes for the ultrasonic return wave 562 to return to the first piezoelectric transducer 522 as the ultrasonic return wave 562. It will be understood from FIG. 5A that when the device 400 is untilted, the second time of flight associated with the second piezoelectric transducer 528 will be substantially equal to the first time of flight associated with the first piezoelectric transducer 522.

By contrast, it will be understood from FIG. 5B that when the device 400 is tilted, the first time of flight and the second time of flight may differ substantially. As was discussed previously, the first fluid 541 displaces the second fluid 542 as the device 400 tilts, flowing downward in the direction of gravity. As a result, the fluid interface 543 between the first fluid 541 and the second fluid 542 becomes closer to the first piezoelectric transducer 522 and becomes further from the second piezoelectric transducer 528. As a result, when the device 400 is tilted clockwise around the y-axis (as depicted in FIG. 5B), the second time of flight associated with the second piezoelectric transducer 528 will be substantially greater than the first time of flight associated with the first piezoelectric transducer 522.

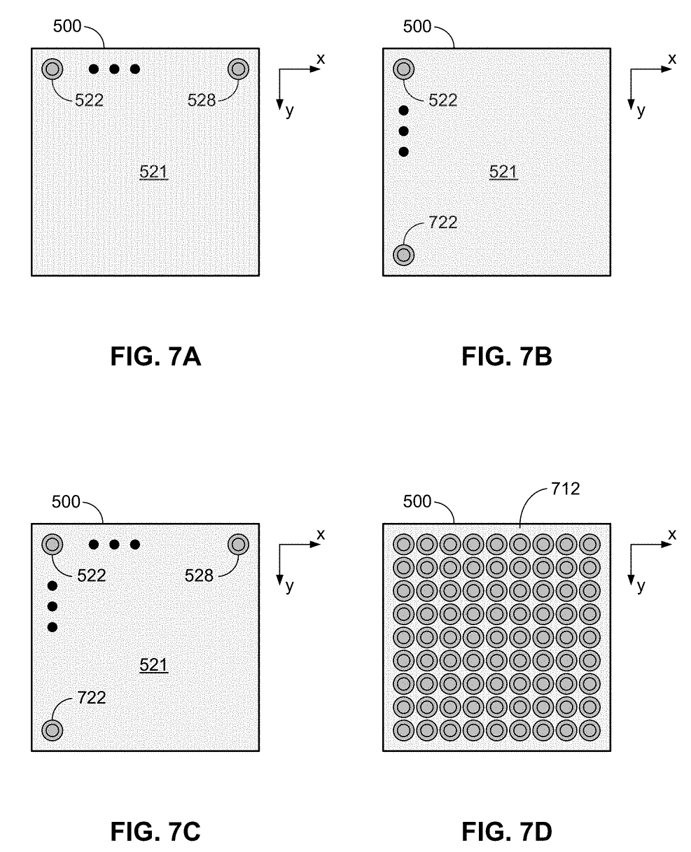

FIGS. 7A-7D illustrate the effects of tilting an ultrasonic tilt sensor in accordance with the method 600 of FIG. 6. In FIGS. 7A-7D, an ultrasonic tilt sensor similar to the ultrasonic tilt sensor 500 is depicted from a top down view, such that the x-axis runs left and right across the surface 521 and the y-axis runs up and down across the surface 521.

FIG. 7A depicts the ultrasonic tilt sensor 500 having the first piezoelectric transducer 522 and the second piezoelectric transducer 528 arranged linearly along a line parallel to the x-axis. Because the ultrasonic tilt sensor 500 has a plurality of piezoelectric transducers arranged along the x-axis, the device 400 may determine a component of tilt around the y-axis (θᵣ). The effect of tilting around the y-axis was discussed previously in the description of FIGS. 5A-5B.

FIG. 7B depicts the ultrasonic tilt sensor 500 having the first piezoelectric transducer 522 and also having a third piezoelectric transducer 722. As will be understood from FIG. 7B, the first piezoelectric transducer 522 and the third piezoelectric transducer 722 are arranged linearly along a line parallel to the y-axis. Because the ultrasonic tilt sensor 500 has a plurality of piezoelectric transducers arranged along the y-axis, the device 400 may determine a component of tilt around the x-axis (θₓ). It will be understood that the effect of tilting around the x-axis is analogous to the effect of tilting around the y-axis, as discussed previously in the description of FIGS. 5A-5B.

FIG. 7C depicts the ultrasonic tilt sensor 500 having the first piezoelectric transducer 522 and the second piezoelectric transducer 528 arranged linearly along a line parallel to the x-axis, and the first piezoelectric transducer 522 and the third piezoelectric transducer 722 arranged linearly along a line parallel to the y-axis. Accordingly, the device 400 may determine both θₓ and θ_{y}. Moreover, the device 400 may determine both θₓ and θ_{y} simultaneously.

FIG. 7D depicts the ultrasonic tilt sensor 500 having a two-dimensional array 712 of piezoelectric transducers arranged in rows (along the x-axis) and columns (along the y-axis). While a nine-by-nine array of piezoelectric transducers is shown in FIG. 7D, other array sizes and configurations may be used such as an m×n array where m and n are integers between two and hundreds or more. In some implementations, the entire piezoelectric transducer array fires at once, such that the same piezoelectric transducer control signal is applied to each of the piezoelectric transducers simultaneously. Moreover, an average amplitude signal associated with a particular row or column may be generated and be used to determine a time of flight value (and consequently, a tilt value). As will be understood from FIG. 7D, if the ultrasonic tilt sensor 500 is tilted clockwise around the y-axis (similar to the rotation in FIG. 5B), the average amplitude signal in the column that includes the first piezoelectric transducer 522 will reach an earlier threshold amplitude (and thus a smaller time of flight) than the average amplitude signal in the column that include the second piezoelectric transducer 528. Accordingly, the tilt component θ_{y} may be determined based on average amplitude signals received from the respective columns of the two-dimensional array depicted in FIG. 7D. Similarly, the tilt component θₓ may be determined based on average amplitude signals received from the respective rows of the two-dimensional array depicted in FIG. 7D.

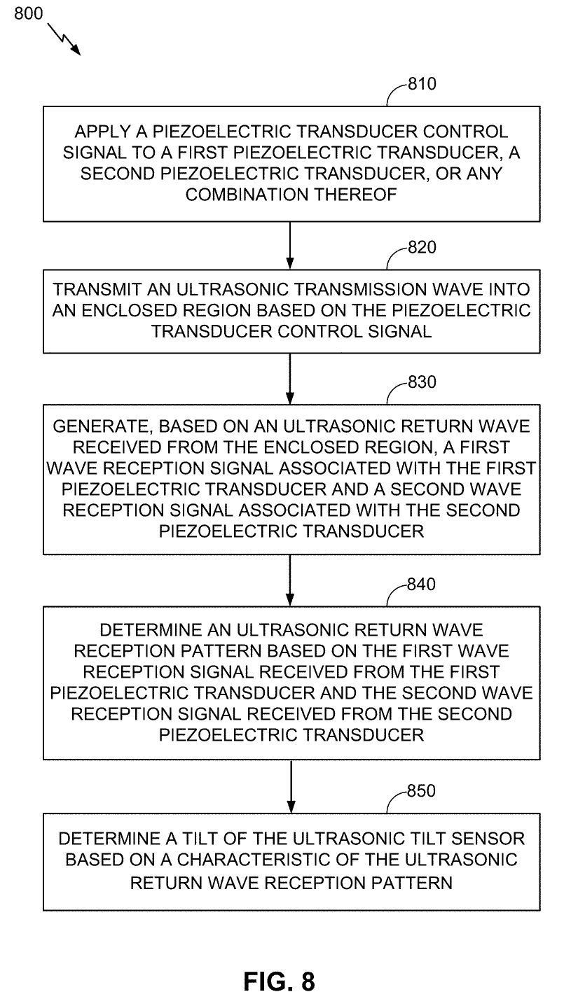

FIG. 8 illustrates a method 800 of determining tilt based on an ultrasonic return wave reception pattern. For purposes of illustration, the method 800 will be described as it would be performed by the device 400 depicted in FIG. 4. Moreover, the device 400 will be assumed to incorporate the ultrasonic tilt sensor 500 depicted in FIGS. 5A-5B.

At 810, the device 400 applies a piezoelectric transducer control signal to the first piezoelectric transducer 522, a second piezoelectric transducer 528, or any combination thereof. The applying at 810 may be performed, for example, by the processor 410 and/or the memory 420 via one or more electrical traces and interconnections. In some implementations, the piezoelectric transducer control signal is a first piezoelectric control signal that is applied to the first piezoelectric transducer 522, and the device 400 further applies a second piezoelectric transducer control signal to the second piezoelectric transducer 528. The first piezoelectric transducer control signal and the second piezoelectric transducer control signal may have respective piezoelectric transducer control signal characteristics that are selected by the processor 410 and/or the memory 420. In some implementations, the signal characteristics of the second piezoelectric transducer control signal may differ from the signal characteristics of the first piezoelectric transducer control signal.

At 820, the device 400 transmits an ultrasonic transmission wave into an enclosed region based on the second piezoelectric transducer control signal. The transmitting at 820 of the first ultrasonic transmission wave 552 and the second ultrasonic transmission wave 558 may be performed, for example, by the first piezoelectric transducer 522, the second piezoelectric transducer 528, or any combination thereof. Accordingly, the ultrasonic transmission wave may include a first ultrasonic transmission wave 552 transmitted by the first piezoelectric transducer 522 and a second ultrasonic transmission wave 558 transmitted by the second piezoelectric transducer 528. The first ultrasonic transmission wave 552 and the second ultrasonic transmission wave 558 may be transmitted in an enclosed region that includes the first fluid 541 and second fluid 542. As discussed previously, the first ultrasonic transmission wave 552 and the second ultrasonic transmission wave 558 may be reflected by a fluid interface 543 between the first fluid 541 and the second fluid 542. Moreover, the first ultrasonic transmission wave 552 and the second ultrasonic transmission wave 558 may be reflected as the first ultrasonic return wave 562 and the second ultrasonic return wave 568, respectively.

At 830, the device 400 generates, based on an ultrasonic return wave received from the enclosed region, a first wave reception signal associated with the first piezoelectric transducer 522 and a second wave reception signal associated with the second piezoelectric transducer 528. The receiving at 830 of the first ultrasonic transmission wave 552 and the second ultrasonic transmission wave 558 may be performed, for example, by the first piezoelectric transducer 522 and the second piezoelectric transducer 528, respectively. As discussed previously, the first wave reception signal and the second wave reception signal may be caused by ultrasonic waves that reflect off of the fluid interface 543 between the first fluid 541 and the second fluid 542 and strike the first piezoelectric transducer 522 and second piezoelectric transducer 528, respectively. The ultrasonic waves may be analogous to the first ultrasonic return wave 562 and the second ultrasonic return wave 568, respectively.

At 840, the device 400 may determine an ultrasonic return wave reception pattern based on the first wave reception signal received from the first piezoelectric transducer 522 and the second wave reception signal received from the second piezoelectric transducer 528. The determining may be performed, for example, by the processor 410 and/or the memory 420. The determining may be performed by analyzing the ultrasonic return wave reception pattern to determine ultrasonic return wave reception pattern signal characteristics. In some implementations, the wave reception pattern may be determined by identifying a wave reception pattern based on a plurality of amplitude values, where the plurality of amplitude values may be determined from a plurality of wave reception signals associated with a plurality of piezoelectric transducers.

The ultrasonic return wave reception pattern may have signal characteristics. In some implementations, the signal characteristics may include spatial signal characteristics. For example, the first wave reception signal received at the first piezoelectric transducer 522 may have a different amplitude than the second wave reception signal received at the second piezoelectric transducer 528 at the same time. As the number of piezoelectric transducers increases, the ultrasonic return wave reception pattern may be revealed as a spatial distribution of amplitudes in accordance with a repeating wave pattern along, for example, the x-axis or the y-axis. In some implementations, the amplitude of the first wave reception signal and/or the second wave reception signal is equal to an average amplitude during an RGW selected by the processor 410 and/or the memory 420. In some implementations, the amplitude of the first wave reception signal and/or the second wave reception signal is equal to a peak amplitude during an RGW when the time duration of the RGW is relatively short and/or when peak detector circuitry is coupled to each of the piezoelectric transducers.

In other implementations, the signal characteristics may include temporal signal characteristics. For example, the first piezoelectric transducer 522 may generate (during the RGW) a first wave reception signal having a first frequency and a first amplitude, and the second piezoelectric transducer 528 may generate (during the RGW) a second wave reception signal having a second frequency and a second amplitude. The first wave reception signal and the second wave reception signal may have different phases, for example, a first phase and a second phase. The respective phases of the first wave reception signal and the second wave reception signal may be determined relative to the phase of the first piezoelectric transducer control signal and/or the second piezoelectric transducer control signal. Additionally or alternatively, the respective phases of the first wave reception signal and the second wave reception signal may be determined relative to one another. For example, in some implementations, the phase of a wave reception signal from a first piezoelectric transducer may be delayed from the wave reception signal from a second piezoelectric transducer when the acoustic path length for the transmitted ultrasonic transmission wave and the received ultrasonic return wave is longer for the first piezoelectric transducer than the second piezoelectric transducer, such as when the device 400 is tilted in a corresponding direction. For example, the transmitted ultrasonic transmission wave may be sinusoidal with one or more cycles and the received ultrasonic return wave may also be sinusoidal with one or more cycles, resulting in a detectable phase difference between the received ultrasonic return waves at two physically separated piezoelectric transducers. The magnitude of the phase difference may be between 0 degrees and 360 degrees or more (or between 0 and 2π radians or more), depending on the acoustic path length and the speed of sound in the transmitting medium.

At 850, the device 400 may determine a tilt of the ultrasonic tilt sensor 500 based on a characteristic of the ultrasonic return wave reception pattern. The determining at 850 may be performed, for example, by the processor 410 and/or the memory 420.

In some implementations, the processor 410 and/or the memory 420 may analyze the spatial signal characteristics of the ultrasonic return wave reception pattern. For example, a plurality of equally-spaced piezoelectric transducers arranged linearly along the x-axis may exhibit an amplitude pattern of high, zero, low, zero, high, zero, etc. The wavelength of the ultrasonic return wave reception pattern (i.e., the distance between high-amplitude piezoelectric transducers) may be determined by the processor 410 and/or the memory 420 and used to determine the tilt of the ultrasonic tilt sensor 500.

In other implementations, the processor 410 and/or the memory 420 may analyze the temporal signal characteristics of the ultrasonic return wave reception pattern. For example, a plurality of equally-spaced piezoelectric transducers arranged linearly along the x-axis may generate wave reception signals having a different phase from one piezoelectric transducer to the next. The relative phase differences from a first piezoelectric transducer to an adjacent piezoelectric transducer may be determined by the processor 410 and/or the memory 420 and used to determine the tilt of the ultrasonic tilt sensor 500.

In some implementations, the processor 410 and/or the memory 420 may use a look-up table stored in the memory 420 to determine the amount of tilt indicated by the result of the comparison. In other implementations, the processor 410 and/or the memory 420 may use an algorithm to determine the amount of tilt indicated by the result of the comparison.

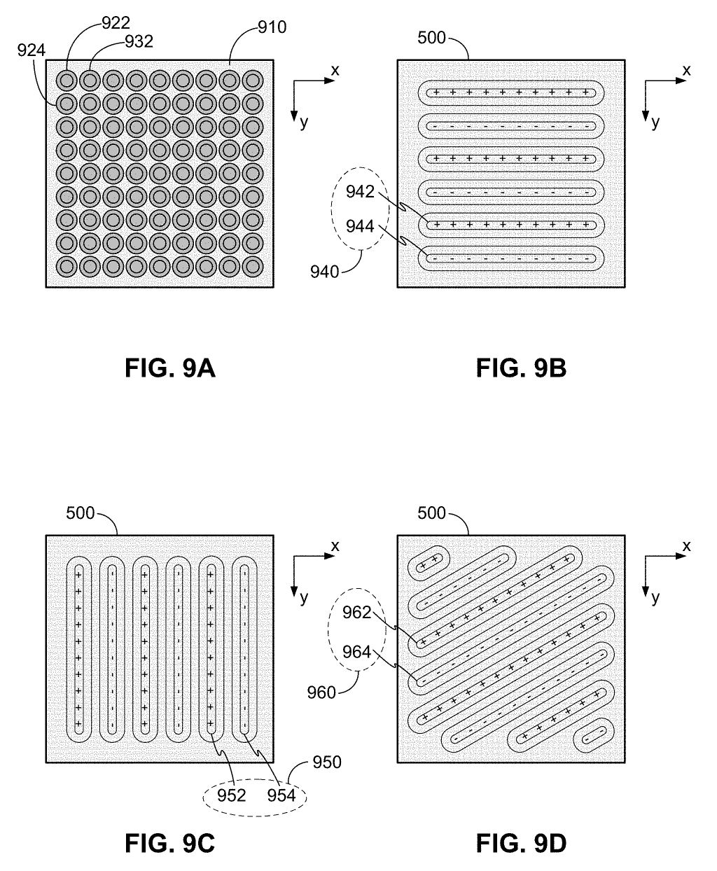

FIGS. 9A-9D illustrate the effects of tilting an ultrasonic tilt sensor in accordance with the method 800 of FIG. 8. In FIGS. 9A-9D, an ultrasonic tilt sensor similar to the ultrasonic tilt sensor 500 is depicted from a top down view, such that the x-axis runs left and right across the surface 521 and the y-axis runs up and down across the surface 521.

FIG. 9A depicts the ultrasonic tilt sensor 500 having an array 910 of piezoelectric transducers. Three piezoelectric transducers in the array 910 have individual reference numerals: a first piezoelectric transducer 922, a second piezoelectric transducer 924, and a third piezoelectric transducer 932. In the present example, each of the piezoelectric transducers in the array 910 may fire at the same time. For example, a piezoelectric transducer control signal may be applied to a common input of each of the piezoelectric transducers in the array 910, or identical piezoelectric transducer control signals may be individually applied to each of the piezoelectric transducers in the array 910.

After a predetermined RGD has elapsed, each of the piezoelectric transducers in the array 910 may generate a wave reception signal. Moreover, the piezoelectric transducers in the array 910 may be separately addressable and the processor 410 and/or the memory 420 may be configured to receive individual wave reception signals from each of the piezoelectric transducers in the array 910. In some implementations, the individual wave reception signals may include an average amplitude value for each of the piezoelectric transducers. For example, the first piezoelectric transducer 922 may generate a first average amplitude value, the second piezoelectric transducer 924 may generate a second average amplitude value, the third piezoelectric transducer 932 may generate a third average amplitude value, and so on throughout the array 910. The average amplitude value for a particular piezoelectric transducer may be, for example, an average amplitude of the ultrasonic return wave received by that particular piezoelectric transducer during the RGW. In some implementations, the average amplitude of the wave reception signal at each piezoelectric transducer may correspond to a peak amplitude detected by a peak detector circuit during the RGW, as the duration of the RGW may be appreciably short compared to the period of a transmitted ultrasonic transmission wave.

In other implementations, the individual wave reception signals may include a plurality of amplitude values captured by the respective piezoelectric transducers. For example, the first piezoelectric transducer 922 may generate a first wave reception signal, the second piezoelectric transducer 924 may generate a second wave reception signal, the third piezoelectric transducer 932 may generate a third wave reception signal, and so on throughout the array 910. Each individual wave reception signal may have, for example, a frequency and a phase. In some implementations, a frame of wave reception signals may be captured at a predetermined RGD and RGW, and the frame of captured data may be clocked out of the sensor chip 520. The piezoelectric transducers in the array 910 may be fired prior to capturing each frame of wave reception signals. In some implementations, multiple frames of wave reception signals may be captured at a predetermined RGD and RGW, and the captured data averaged to determine an average amplitude value from each of the piezoelectric transducers in the piezoelectric transducer array 910. In some implementations, multiple frames of wave reception signals may be captured at different RGDs, allowing reconstruction of the time-dependent wave reception signals at each piezoelectric transducer of interest. Analysis of the captured time-dependent wave reception signals allows a frequency and/or a phase of each individual wave reception signal to be determined.

FIG. 9B illustrates the effect of tilting the ultrasonic tilt sensor 500 around the x-axis in accordance with aspects of the disclosure.

As noted above, the piezoelectric transducers in the array 910 may be configured to fire at the same time. Moreover, the piezoelectric transducer control signal that is transmitted to the piezoelectric transducers in the array 910 may have a predetermined phase and frequency selected by the processor 410 and/or the memory 420.

In an untilted scenario, each of the piezoelectric transducers in the array 910 may simultaneously transmit the same ultrasonic transmission wave (having a phase and frequency similar to the piezoelectric transducer control signal). Each individual ultrasonic transmission wave may be reflected directly backward as an ultrasonic return wave (having the same frequency as the piezoelectric transducer control signal with a different phase). The ultrasonic return wave may be received during the RGW at the piezoelectric transducer that initially generated the ultrasonic transmission wave. As a result, the respective wave reception signals generated by each of the piezoelectric transducers in the array 910 may be similar. For example, the respective wave reception signals generated by each of the piezoelectric transducers in the array 910 may have substantially similar amplitudes at the same RGD. Additionally or alternatively, the respective wave reception signals generated by each of the piezoelectric transducers in the array 910 may have the same frequency and phase.

By contrast, in the scenario of FIG. 9B, the ultrasonic tilt sensor 500 is tilted around the x-axis. As a result, each individual ultrasonic transmission wave may strike the fluid interface at an angle, and the returning ultrasonic return wave may be deflected. Consider a scenario in which a first ultrasonic transmission wave transmitted by the first piezoelectric transducer 922 returns as a first ultrasonic return wave, and a second ultrasonic transmission wave transmitted by the second piezoelectric transducer 924 returns as a second ultrasonic return wave. Because the ultrasonic tilt sensor 500 is tilted around the x-axis, the first ultrasonic transmission wave and the first ultrasonic return wave may travel a different combined distance than the second ultrasonic transmission wave and the second ultrasonic return wave. Moreover, because the first ultrasonic return wave and the second ultrasonic return wave have traveled different distances, they may have different phases.

In some implementations, the RGW may be substantially shorter than the period of the returning ultrasonic return waves, and a phase difference between the first ultrasonic return wave and the second ultrasonic return wave may cause a first amplitude value captured at the first piezoelectric transducer 922 during the RGW to differ substantially from a second amplitude value captured at the second piezoelectric transducer 924 during the same RGW. For example, the first ultrasonic return wave may be at a positive amplitude during the RGW and the second ultrasonic return wave may be at a negative amplitude during the RGW. As a result, the amplitude value generated by the first piezoelectric transducer 922 may be a positive value and the amplitude value generated by the second piezoelectric transducer 924 may be a negative value.

As can be seen from FIG. 9B, the differing amplitude values generated by the piezoelectric transducers in the array 910 may be expressed as an ultrasonic return wave reception pattern 940 having spatial signal characteristics. In FIG. 9B, the ultrasonic return wave reception pattern 940 has repeating positive regions 942 and repeating negative regions 944. The positive regions 942 represent piezoelectric transducers (or subsets of piezoelectric transducers) that generate a high amplitude value during the RGW, and the negative regions 944 represent piezoelectric transducers (or subsets of piezoelectric transducers) that generate a low amplitude value during the RGW.

The distance between peaks of adjacent positive regions 942 or between peaks of adjacent negative regions 944 may constitute a wavelength of the ultrasonic return wave reception pattern 940. Moreover, the processor 410 and/or the memory 420 may be configured to analyze the wavelength (or some other signal characteristic of the ultrasonic return wave reception pattern 940) to determine a tilt of the ultrasonic tilt sensor 500.

In some implementations with the RGW substantially shorter than the period of the returning ultrasonic return waves, the relative phases of a first wave reception signal (generated by the first piezoelectric transducer 922) and a second wave reception signal (generated by the second piezoelectric transducer 924) may be determined directly. In these implementations, the differing phase values of the wave reception signals generated by the piezoelectric transducers in the array 910 may be expressed as an ultrasonic return wave reception pattern 940 having temporal signal characteristics. The repeating positive regions 942 of FIG. 9B may represent piezoelectric transducers (or subsets of piezoelectric transducers) that generated a wave reception signal having a positive phase (for example, between zero and it), and the repeating negative regions 944 may represent piezoelectric transducers (or subsets of piezoelectric transducers) that generated a wave reception signal having a negative phase (for example, between −π and zero).

As in the previously-described implementation, the distance between adjacent peaks of positive regions 942 or adjacent peaks of negative regions 944 may constitute a wavelength of the ultrasonic return wave reception pattern 940. Moreover, the processor 410 and/or the memory 420 may be configured to analyze the wavelength (or some other signal characteristic of the ultrasonic return wave reception pattern 940) to determine a tilt of the ultrasonic tilt sensor 500.

In the example of FIG. 9B, in which the ultrasonic tilt sensor 500 is tilted around the x-axis, the peaks of positive regions 942 and the peaks of negative regions 944 are separated along the y-axis. However, as can be understood from FIGS. 9C-9D, the processor 410 and/or the memory 420 may also determine tilt of the ultrasonic tilt sensor 500 around the y-axis.

FIG. 9C illustrates the effect of tilting the ultrasonic tilt sensor 500 around the y-axis in accordance with aspects of the disclosure. As will be understood from the foregoing, tilting of the ultrasonic tilt sensor 500 around the y-axis causes an ultrasonic return wave reception pattern 950 having peaks in positive regions 952 and peaks in negative regions 954 that are separated along the x-axis.

FIG. 9D illustrates the effect of tilting the ultrasonic tilt sensor 500 around the x-axis and the y-axis in accordance with aspects of the disclosure. As will be understood from the foregoing, tilting of the ultrasonic tilt sensor 500 around both the x-axis and the y-axis causes an ultrasonic return wave reception pattern 960 having peaks in positive regions 962 and peaks in negative regions 964 that are separated along a line having an x-component and a y-component.

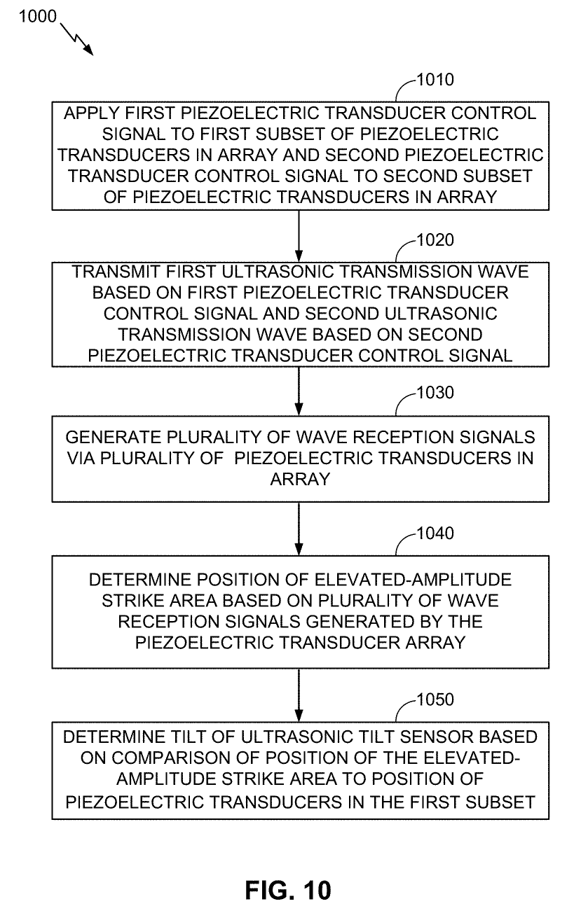

FIG. 10 illustrates a method 1000 of determining tilt based on a position of a high-amplitude strike area in a piezoelectric transducer array on the surface 521. For purposes of illustration, the method 1000 will be described as it would be performed by the device 400 depicted in FIG. 4. Moreover, the device 400 will be assumed to incorporate the ultrasonic tilt sensor 500 depicted in FIGS. 5A-5B.

At 1010, the device 400 applies a first piezoelectric transducer control signal to a first subset of piezoelectric transducers in the array and a second piezoelectric transducer control signal to a second subset of piezoelectric transducers in the array. Both the first subset and the second subset may include at least one piezoelectric transducer. Moreover, the first subset and the second subset may not have any piezoelectric transducers in common. Moreover, each piezoelectric transducer in the array may be included in either the first subset or the second subset. The applying at 1010 may be performed, for example, by the processor 410 and/or the memory 420. The first piezoelectric transducer control signal and second piezoelectric transducer control signal may have respective piezoelectric transducer control signal characteristics that are selected by the processor 410 and/or the memory 420. Moreover, the first piezoelectric transducer control signal may have at least one signal characteristic that distinguishes it from the second piezoelectric transducer control signal. For example, the first piezoelectric transducer control signal may have a nonzero amplitude and the second piezoelectric transducer control signal may have an amplitude of zero. In another example, the first piezoelectric transducer control signal may have a positive amplitude and the second piezoelectric transducer control signal may have a negative amplitude (e.g., 180 degrees out of phase with the first piezoelectric transducer control signal). The first piezoelectric transducer control signal and/or the second piezoelectric transducer control signal may include a waveform having a predetermined shape, amplitude, frequency and/or phase, a pulse having a predetermined duration, a sequence of one or more cycles, or any other appropriate shape.

At 1020, the device 400 transmits a first ultrasonic transmission wave 552 based on the first piezoelectric transducer control signal and a second ultrasonic transmission wave 558 based on the second piezoelectric transducer control signal. The generating and transmitting at 1020 of the first ultrasonic transmission wave 552 and the second ultrasonic transmission wave 558 may be performed, for example, by the piezoelectric transducers in the first subset and the piezoelectric transducers in the second subset, respectively. The first ultrasonic transmission wave 552 and/or the second ultrasonic transmission wave 558 may be transmitted in an enclosed region that includes the first fluid 541 and second fluid 542. As discussed previously, a portion of the first ultrasonic transmission wave 552 and/or the second ultrasonic transmission wave 558 may be reflected by a fluid interface 543 between the first fluid 541 and the second fluid 542. Moreover, the first ultrasonic transmission wave 552 and/or the second ultrasonic transmission wave 558 may be reflected as the first ultrasonic return wave 562 and the second ultrasonic return wave 568, respectively. As discussed previously, the second piezoelectric transducer control signal may have an amplitude of zero, in which case the piezoelectric transducers in the second subset would not generate the second ultrasonic transmission wave 558, and the fluid interface 543 would return the second ultrasonic return wave 568 with a zero value.

At 1030, the device 400 generates a plurality of wave reception signals via a plurality of piezoelectric transducers in the array. As discussed previously, the plurality of wave reception signals may be caused by a portion of the ultrasonic transmission waves that reflect off of the fluid interface 543 between the first fluid 541 and the second fluid 542 and strike the piezoelectric transducers arrayed on the surface 521.

At 1040, the device 400 determines a position of an elevated-amplitude strike area based on the plurality of wave reception signals generated by the piezoelectric transducer array. The determining at 1040 may be performed, for example, by the processor 410 and/or the memory 420.

As an example, the piezoelectric transducers on the surface 521 may be separately addressable, and the processor 410 and/or the memory 420 may receive one or more wave reception signals from each piezoelectric transducer in the array. In some implementations, the processor 410 and/or the memory 420 may identify a particular piezoelectric transducer having the wave reception signal with the highest peak amplitude. The processor 410 and/or the memory 420 may then determine a position of the identified piezoelectric transducer based on, for example, array data stored in the memory 420.

In other implementations, the processor 410 and/or the memory 420 may identify a strike area subset of piezoelectric transducers having wave reception signals with peak amplitudes that exceed a wave reception signal amplitude threshold. The processor 410 and/or the memory 420 may then identify a feature of the subset (for example, the geometric center of the subset) and further determine a position of the identified feature.

At 1050, the device 400 determines a tilt of the ultrasonic tilt sensor 500 based on a comparison of the position of the elevated-amplitude strike area to a position of the piezoelectric transducers in the first subset. The position of the piezoelectric transducers in the first subset may be based on a first subset position value that is predetermined and stored in the memory 420. Additionally or alternatively, the position of the piezoelectric transducers in the first subset may be determined based on an identified feature (for example, the geometric center) of the first subset. The position of the piezoelectric transducers in the first subset may be, for example, stored in the memory 420 and/or determined based on array data stored in the memory 420. The result of the comparison may be a distance value. The distance value may have a component along the x-axis and/or a component along the y-axis.

In some implementations, the processor 410 and/or the memory 420 may use a look-up table stored in the memory 420 to determine the amount of tilt indicated by the result of the comparison. In other implementations, the processor 410 and/or the memory 420 may use an algorithm to determine the amount of tilt indicated by the result of the comparison. For example, the centroid of the piezoelectric transducers in the first subset may be compared to the centroid of the elevated-amplitude wave reception signals above a background level in each of the x- and y-directions, and the angle of tilt in each of the x- and y-directions may be determined by multiplying the difference between the centroids in each of the x- and y-directions by a suitable scale factor.

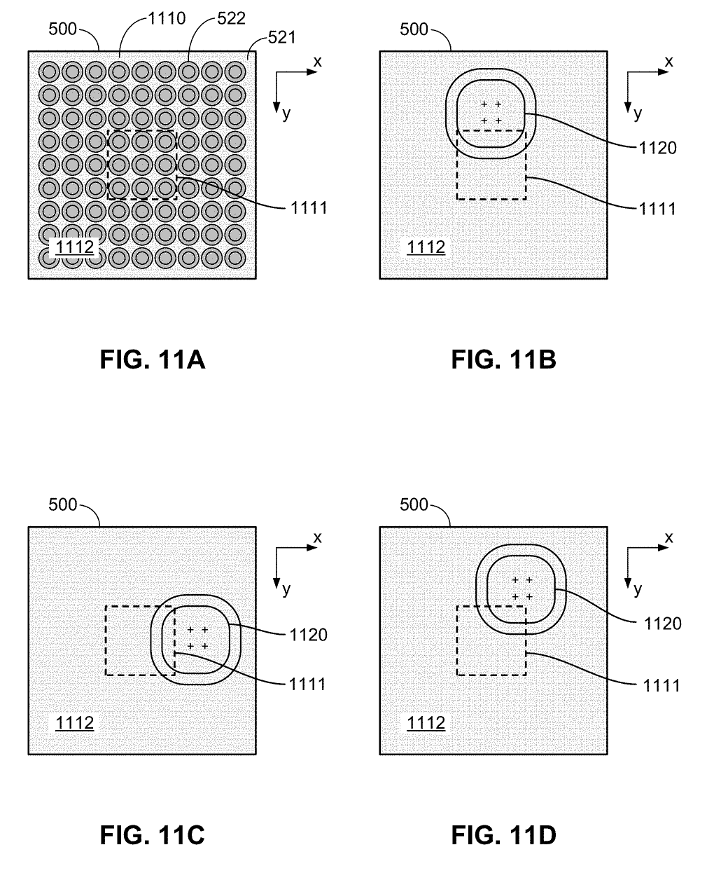

The correlation between the position of the high-amplitude strike area and tilt will be further described with reference to FIGS. 11A-11D.

FIGS. 11A-11D illustrate the effects of tilting an ultrasonic tilt sensor in accordance with the method 1000 of FIG. 10. In FIGS. 11A-11D, an ultrasonic tilt sensor similar to the ultrasonic tilt sensor 500 is depicted from a top down view, such that the x-axis runs left and right across the surface 521 and the y-axis runs up and down across the surface 521.

FIG. 11A depicts the ultrasonic tilt sensor 500 having an array 1110 of piezoelectric transducers 522. The array 1110 includes a first subset 1111 that includes one or more of the piezoelectric transducers 522. In FIGS. 11A-11B, the first subset 1111 includes the nine centermost piezoelectric transducers 522 in the array 1110, although it will be understood that other arrangements are possible, such as small rectangular or square arrays, single piezoelectric transducers, rows or columns of piezoelectric transducers, or portions of rows and/or columns. The array 1110 further includes a second subset 1112 that includes a portion or all of the remaining piezoelectric transducers 522, i.e., some or all of the piezoelectric transducers 522 that are not included in the first subset 1111.

FIG. 11B illustrates the effect of tilting the ultrasonic tilt sensor 500 around the x-axis in accordance with aspects of the disclosure.

As noted above, the processor 410 and/or the memory 420 may be configured to apply the first piezoelectric transducer control signal to the first subset 1111 and the second piezoelectric transducer control signal to the second subset 1112. The first piezoelectric transducer control signal and the second piezoelectric transducer control signal may have different signal characteristics. For example, the first piezoelectric transducer control signal may have a nonzero amplitude and the second piezoelectric transducer control signal may have an amplitude of zero. The first piezoelectric transducer control signal may include a waveform having a predetermined shape, amplitude, frequency and/or phase, a pulse having a predetermined duration, a sequence of one or more cycles, or any other appropriate shape. Similarly, the second piezoelectric transducer control signal may include a waveform having a predetermined shape, amplitude, frequency and/or phase, a pulse having a predetermined duration, a sequence of one or more cycles, or any other appropriate shape. In some implementations, the piezoelectric transducer control signal applied to the second subset 1112 or a portion thereof may have an opposite phase, e.g., a negative amplitude compared to the piezoelectric transducer control signal applied to the first subset 1111 to aid in focusing the outgoing ultrasonic transmission wave onto the fluidic interface. In some implementations, the phase of the piezoelectric transducer control signal applied to the second subset 1112 or a portion thereof may be ahead of or behind the piezoelectric transducer control signal applied to the first subset 1111 to control the direction and shape of the outgoing ultrasonic transmission wave (e.g. transmit-side beamforming). While in some implementations the outgoing ultrasonic transmission wave may be focused or partially focused onto the fluidic interface, in some implementations the outgoing ultrasonic transmission wave may be beamformed so that the ultrasonic return wave is focused or partially focused onto the piezoelectric transducer array to reduce sloshing and undulations of the fluidic interface when struck with the ultrasonic transmission wave, improving the detected signals in part due to the reduction in the acoustic pressure level at the interface.

When the processor 410 and/or the memory 420 apply the first piezoelectric transducer control signal to the first subset 1111 and the second piezoelectric transducer control signal to the second subset 1112, the result is that the piezoelectric transducers 522 within the first subset 1111 deform in response to the piezoelectric transducer control signal, generate an ultrasonic transmission wave, and transmit the ultrasonic transmission wave piezoelectric transducer into the first fluid 541 (as depicted in FIGS. 5A-5B). Because the first fluid 541 and the second fluid 542 have different acoustic impedances (as discussed previously), at least a portion of the ultrasonic transmission wave transmitted by the first subset 1111 may be reflected off of the fluid interface 543, thereby generating an ultrasonic return wave. The ultrasonic return wave may then travel through the first fluid 541 and strike one or more of the piezoelectric transducers 522, thereby generating a wave reception signal.

In an untilted scenario wherein the ultrasonic tilt sensor 500 is not tilted with respect to gravity, the fluid interface 543 between the first fluid 541 and the second fluid 542 is substantially parallel to the surface 521 upon which the piezoelectric transducer array 1110 is disposed. Accordingly, the ultrasonic transmission wave transmitted by the first subset 1111 will be substantially perpendicular to the fluid interface 543, and the ultrasonic return wave will be reflected directly backwards toward the first subset 1111. As a result, the piezoelectric transducers 522 within the first subset 1111 will be struck hardest by the ultrasonic return wave and generate the largest wave reception signals.

By contrast, in the scenario of FIG. 11B, the ultrasonic tilt sensor 500 is tilted around the x-axis. As a result, the ultrasonic transmission wave transmitted by the first subset 1111 will strike the fluid interface 543 at an angle, and the ultrasonic return wave will be deflected. Moreover, the degree of deflection of the ultrasonic return wave will correlate to the degree of tilt of the ultrasonic tilt sensor 500. FIG. 11B shows a strike area 1120 where the deflected ultrasonic return wave strikes hardest.

Because the ultrasonic return wave strikes hardest on the strike area 1120, the amplitude of the wave reception signal generated at the piezoelectric transducers 522 within the strike area 1120 will be greater than the amplitude of the wave reception signal generated at the piezoelectric transducers 522 outside of the strike area 1120. For example, an average wave reception signal value may be determined for each row and/or column in the array 1110.

In the example of FIG. 11B, in which the ultrasonic tilt sensor 500 is tilted around the x-axis, the displacement between the first subset 1111 and the strike area 1120 will be along the y-axis. However, as can be understood from FIGS. 11C-11D, the processor 410 and/or the memory 420 may also determine tilt of the ultrasonic tilt sensor 500 around the y-axis.

FIG. 11C illustrates the effect of tilting the ultrasonic tilt sensor 500 around the y-axis in accordance with aspects of the disclosure. As will be understood from the foregoing, tilting of the ultrasonic tilt sensor 500 around the y-axis causes a displacement along the x-axis between the first subset 1111 and the strike area 1120.

FIG. 11D illustrates the effect of tilting the ultrasonic tilt sensor 500 around the x-axis and the y-axis in accordance with aspects of the disclosure. As will be understood from the foregoing, tilting of the ultrasonic tilt sensor 500 around both the x-axis and the y-axis causes displacements along the y-axis and x-axis, respectively, between the first subset 1111 and the strike area 1120.

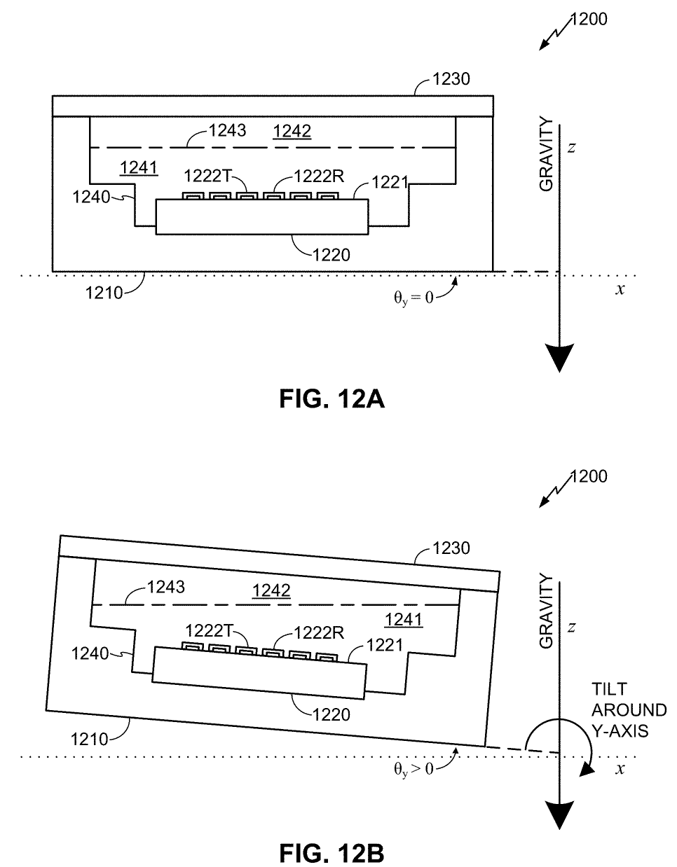

FIGS. 12A-12B illustrate a side view of an example of an ultrasonic tilt sensor 1200 in accordance with aspects of the disclosure. FIG. 12A illustrates the ultrasonic tilt sensor 1200 in a condition in which the ultrasonic tilt sensor 1200 is not tilted with respect to gravity. FIG. 12B illustrates the ultrasonic tilt sensor 1200 in a condition in which the ultrasonic tilt sensor 1200 is tilted with respect to gravity.

The elements depicted in FIGS. 12A-12B are analogous in some respects to the elements depicted in FIGS. 2A-2B. For example, the ultrasonic tilt sensor 1200 may include an integrated circuit package 1210 that supports a sensor chip 1220 having a surface 1221 (analogous to the integrated circuit package 210 that supports a sensor chip 220 having a surface 221). The ultrasonic tilt sensor 1200 may further include a cover 1230 (analogous to the cover 230) that is fitted to the integrated circuit package 1210 and an enclosed region 1240 (analogous to the enclosed region 240). The enclosed region 1240 may be filled or partially filled with a first fluid 1241 and a second fluid 1242 (analogous to the first fluid 241 and the second fluid 242).

Similar to FIGS. 2A-2B, gravity is depicted in FIGS. 12A-12B as a downward arrow. A z-axis is arbitrarily defined as being parallel with the direction of the gravitational force, whereas an x-axis (depicted as a dotted line) and a y-axis (not depicted) are arbitrarily defined as being within or parallel to a plane that is perpendicular to the direction of gravity. The tilt θ of the ultrasonic tilt sensor 1200 may be defined as an angular difference between some predetermined plane associated with the ultrasonic tilt sensor 1200 and a plane that is perpendicular to the direction of gravity (depicted in FIGS. 12A-12B as a dotted line, as noted above). As an example, the tilt θ of the ultrasonic tilt sensor 1200 may be defined as an angular difference between the surface 1221 (upon which the piezoelectric transducers 1222 are disposed) and a plane that is perpendicular to the direction of gravity. It will be understood that the tilt θ may have an x-component θₓ and a y-component θ_{y}.

The surface 1221 may have transmitting piezoelectric transducers 1222T and receiving piezoelectric transducers 1222R disposed thereon. The transmitting piezoelectric transducers 1222T and receiving piezoelectric transducers 1222R may be analogous in some respects to the piezoelectric transducers 222 described above with respect to FIGS. 2A-FIG. 2B. For example, the transmitting piezoelectric transducers 1222T and receiving piezoelectric transducers 1222R may be disposed on the surface 1221.

Like the piezoelectric transducers 222, the transmitting piezoelectric transducers 1222T and the receiving piezoelectric transducers 1222R may be configured to generate and transmit ultrasonic waves and/or generate a piezoelectric output signal when receiving a reflected ultrasonic wave. However, unlike the piezoelectric transducers 222, the transmitting piezoelectric transducers 1222T and receiving piezoelectric transducers 1222R may be divided into piezoelectric transducers that generate and transmit ultrasonic waves (i.e., the transmitting piezoelectric transducers 1222T) and piezoelectric transducers that generate a piezoelectric output signal when receiving a reflected ultrasonic wave (i.e., the receiving piezoelectric transducers 1222R). In some implementations, the transmitting piezoelectric transducers 1222T may be dedicated for transmission and configured solely for generating and transmitting ultrasonic waves, whereas the receiving piezoelectric transducers 1222R may be dedicated for receiving and configured solely for generating a piezoelectric output signal when receiving a reflected ultrasonic wave. In other implementations, each of the transmitting piezoelectric transducers 1222T and each of the receiving piezoelectric transducers 1222R is configured for both transmitting and receiving, but each is selectively designated to either transmit or receive. The designation may be performed during a design process or calibration process, or the designation may be performed dynamically by, for example, a motion unit similar to the motion unit 460 depicted in FIG. 4 and/or a processor similar to the processor 410 depicted in FIG. 4.

The transmitting piezoelectric transducers 1222T and the receiving piezoelectric transducers 1222R may be arranged in accordance with any suitable pattern. For example, the transmitting piezoelectric transducers 1222T and receiving piezoelectric transducers 1222R may be paired such that each of the transmitting piezoelectric transducers 1222T is adjacent to at least one of the receiving piezoelectric transducers 1222R. For example, the transmitting piezoelectric transducers 1222T depicted in FIG. 12A may be paired with the receiving piezoelectric transducers 1222R depicted in FIG. 12B.

In some implementations, the paired piezoelectric transducers may be closely adjacent or immediately adjacent such that the difference in position between the transmitting piezoelectric transducers 1222T and the receiving piezoelectric transducers 1222R is negligible for purposes of determining tilt. In other implementations, a distance between the paired piezoelectric transducers is predetermined and taken into account when determining tilt.

In some implementations, a first piezoelectric transducer configured for transmitting, receiving or both transmitting and receiving may be positioned at a different location and height within the package 1210 than a second piezoelectric transducer that may also be configured for transmitting, receiving or both transmitting and receiving. For example, the first piezoelectric transducer may be formed on a first substrate and the second piezoelectric transducer may be formed on a second substrate different from or separated from the first, and each transducer may be positioned at opposite sides of the sensor package 1210.

The methods disclosed herein may be implemented in various ways consistent with the teachings herein. In some designs, the methods are performed by functional modules. The functionality of these modules may be implemented as one or more electrical components. In some designs, the functionality of these modules may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions described herein may be implemented using any suitable means. Such means also may be implemented, at least in part, using corresponding structures as taught herein. For example, the functional modules described above may correspond to similarly designated “code for” functionality. Thus, in some aspects one or more of such means may be implemented using one or more of processor components, integrated circuits, or other suitable structures as taught herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.”

In view of the descriptions and explanations above, one skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in Random-Access Memory (RAM), flash memory, Read-only Memory (ROM), Erasable Programmable Read-only Memory (EPROM), Electrically Erasable Programmable Read-only Memory (EEPROM), registers, hard disk, a removable disk, a CD-ROM, or any other form of non-transitory storage medium known in the art. As used herein the term “non-transitory” does not exclude any physical storage medium or memory and particularly does not exclude dynamic memory (e.g., RAM) but rather excludes only the interpretation that the medium can be construed as a transitory propagating signal. An example storage medium is coupled to the processor such that the processor can read information from, and write information to, the storage medium. In the alternative, the storage medium may be integral to the processor (e.g., cache memory).

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A device comprising:
a surface at least partially defining an enclosed region;
a plurality of fluids within the enclosed region, the plurality of fluids comprising at least a first fluid having a first acoustic impedance and a second fluid having a second acoustic impedance different from the first acoustic impedance;
a first piezoelectric transducer disposed on the surface, the first piezoelectric transducer being configured to generate a first wave reception signal based, at least in part, on an ultrasonic return wave received through at least one of the plurality of fluids; and
a processor coupled to the first piezoelectric transducer and configured to determine a measurement of a tilt of the device based, at least in part, on the first wave reception signal.

2. The device of claim 1, wherein:
the first piezoelectric transducer is further configured to receive a first piezoelectric transducer control signal and transmit a first ultrasonic transmission wave through at least one of the plurality of fluids based on the first piezoelectric transducer control signal; and
at least a portion of the ultrasonic return wave comprises a reflected portion of the first ultrasonic transmission wave.

3. The device of claim 1, wherein:
the device includes a plurality of piezoelectric transducers comprising at least the first piezoelectric transducer and a second piezoelectric transducer, wherein the second piezoelectric transducer is configured to receive a piezoelectric transducer control signal and transmit a first ultrasonic transmission wave through at least one of the plurality of fluids based on the piezoelectric transducer control signal; and
at least a portion of the ultrasonic return wave received through at least one of the plurality of fluids by the first piezoelectric transducer comprises a reflected portion of the first ultrasonic transmission wave.

4. The device of claim 3, wherein the second piezoelectric transducer is further configured to generate a second wave reception signal based, at least in part, on another reflected portion of the ultrasonic return wave as received by the second piezoelectric transducer through at least one of the plurality of fluids.

5. The device of claim 3, wherein:
the surface defines a first part of the enclosed region; and
the second piezoelectric transducer is disposed on a second surface that defines a second part of the enclosed region that is exclusive to the first part of the enclosed region.

6. The device of claim 1, wherein the processor is further configured to:
determine a first time of flight based on the first wave reception signal received from the first piezoelectric transducer and a second time of flight based on a second wave reception signal received from a second piezoelectric transducer; and
determine the measurement of the tilt of the device based on a comparison of the first time of flight and the second time of flight.

7. The device of claim 6, wherein the processor is further configured to determine the measurement of the tilt of the device based on a distance between the first piezoelectric transducer and the second piezoelectric transducer.

8. The device of claim 6, wherein the processor is further configured to:
determine a phase difference between a first phase corresponding to the first wave reception signal and a second phase corresponding to the second wave reception signal received from the second piezoelectric transducer; and
determine the measurement of the tilt of the device based on the phase difference.

9. The device of claim 6, wherein the processor is further configured to:
select a frequency and a transmission timing of a first piezoelectric transducer control signal and a second piezoelectric transducer control signal;
select a range-gate delay that follows the first piezoelectric transducer control signal and the second piezoelectric transducer control signal; and
select a range-gate window, wherein the range-gate window follows the range-gate delay, and wherein the first wave reception signal and the second wave reception signal are acquired during the range-gate window.

10. The device of claim 4, wherein the processor is further configured to:
determine a first amplitude value corresponding to the first wave reception signal;
determine a second amplitude value corresponding to the second wave reception signal; and
determine the measurement of the tilt of the device based, at least in part, on the first amplitude value and the second amplitude value.

11. The device of claim 10, wherein the processor is further configured to:
determine a plurality of amplitude values corresponding to a plurality of wave reception signals for at least a subset of the plurality of piezoelectric transducers;
identify a wave reception pattern based, at least in part, on the plurality of amplitude values; and
determine the measurement of the tilt of the device based, at least in part, on the wave reception pattern.

12. The device of claim 2, wherein the processor is further configured to apply a first piezoelectric transducer control signal to the first piezoelectric transducer and a second piezoelectric transducer control signal to a second piezoelectric transducer, wherein the second piezoelectric transducer control signal has at least one different signal characteristic than the first piezoelectric transducer control signal.

13. The device of claim 1, wherein the processor is further configured to:
compare the first wave reception signal and a second wave reception signal received from a second piezoelectric transducer to a wave reception signal amplitude threshold;
determine a position of a strike area on the surface based, at least in part, on the comparison; and
determine the measurement of the tilt of the device based, at least in part, on the position of the strike area on the surface.

14. A method comprising:
generating, with a first piezoelectric transducer, a first wave reception signal based, at least in part, on an ultrasonic return wave received through at least one of a plurality of fluids, wherein:
the first piezoelectric transducer is disposed on a surface at least partially defining an enclosed region,
the plurality of fluids are within the enclosed region, and
the plurality of fluids comprise at least a first fluid having a first acoustic impedance and a second fluid having a second acoustic impedance different from the first acoustic impedance; and
determining a measurement of a tilt of a device based, at least in part, on the first wave reception signal.

15. The method of claim 14, further comprising:
receiving, with the first piezoelectric transducer, a first piezoelectric transducer control signal; and
transmitting, with the first piezoelectric transducer, a first ultrasonic transmission wave through at least one of the plurality of fluids based on the first piezoelectric transducer control signal;
wherein at least a portion of the ultrasonic return wave comprises a reflected portion of the first ultrasonic transmission wave.

16. The method of claim 14, further comprising:
receiving, with a second piezoelectric transducer, a piezoelectric transducer control signal; and
transmitting, with the second piezoelectric transducer, a first ultrasonic transmission wave through at least one of the plurality of fluids based on the piezoelectric transducer control signal;
wherein at least a portion of the ultrasonic return wave received through at least one of the plurality of fluids by the first piezoelectric transducer comprises a reflected portion of the first ultrasonic transmission wave.

17. The method of claim 16, further comprising:
generating, with the second piezoelectric transducer, a second wave reception signal based, at least in part, on another reflected portion of the ultrasonic return wave as received by the second piezoelectric transducer through at least one of the plurality of fluids.

18. The method of claim 16, wherein the surface defines a first part of the enclosed region and the second piezoelectric transducer is disposed on a second surface that defines a second part of the enclosed region that is exclusive to the first part of the enclosed region.

19. The method of claim 14, further comprising:
determining a first time of flight based on the first wave reception signal received from the first piezoelectric transducer and a second time of flight based on a second wave reception signal received from a second piezoelectric transducer; and
determining the measurement of the tilt of the device based on a comparison of the first time of flight and the second time of flight.

20. The method of claim 19, further comprising determining the measurement of the tilt of the device based on a distance between the first piezoelectric transducer and the second piezoelectric transducer.

21. The method of claim 19, further comprising:
determining a phase difference between a first phase corresponding to the first wave reception signal and a second phase corresponding to the second wave reception signal received from the second piezoelectric transducer; and
determining the measurement of the tilt of the device based on the phase difference.

22. The method of claim 19, further comprising:
selecting a frequency and a transmission timing of a first piezoelectric transducer control signal and a second piezoelectric transducer control signal;
selecting a range-gate delay that follows the first piezoelectric transducer control signal and the second piezoelectric transducer control signal; and
selecting a range-gate window, wherein the range-gate window follows the range-gate delay, and wherein the first wave reception signal and the second wave reception signal are acquired during the range-gate window.

23. The method of claim 17, further comprising:
determining a first amplitude value corresponding to the first wave reception signal;
determining a second amplitude value corresponding to the second wave reception signal; and
determining the measurement of the tilt of the device based, at least in part, on the first amplitude value and the second amplitude value.

24. The method of claim 23, further comprising:
determining a plurality of amplitude values corresponding to a plurality of wave reception signals for at least a subset of a plurality of piezoelectric transducers;
identifying a wave reception pattern based, at least in part, on the plurality of amplitude values; and
determining the measurement of the tilt of the device based, at least in part, on the wave reception pattern.

25. The method of claim 15, further comprising applying a first piezoelectric transducer control signal to the first piezoelectric transducer and a second piezoelectric transducer control signal to a second piezoelectric transducer, wherein the second piezoelectric transducer control signal has at least one different signal characteristic than the first piezoelectric transducer control signal.

26. The method of claim 14, further comprising:
comparing the first wave reception signal and a second wave reception signal received from a second piezoelectric transducer to a wave reception signal amplitude threshold;
determining a position of a strike area on the surface based, at least in part, on the comparison; and
determining the measurement of the tilt of the device based, at least in part, on the position of the strike area on the surface.

27. A device comprising:
means for generating a first wave reception signal, being disposed on a surface at least partially defining an enclosed region, the first wave reception signal being based, at least in part, on an ultrasonic return wave received through at least one of a plurality of fluids, wherein:
the plurality of fluids are within the enclosed region, and
the plurality of fluids comprise at least a first fluid having a first acoustic impedance and a second fluid having a second acoustic impedance different from the first acoustic impedance; and
means for determining a measurement of a tilt of the device based, at least in part, on the first wave reception signal.

28. The device of claim 27, means for generating the first wave reception signal further comprising:
means for receiving a first piezoelectric transducer control signal; and
means for transmitting a first ultrasonic transmission wave through at least one of the plurality of fluids based on the first piezoelectric transducer control signal;
wherein at least a portion of the ultrasonic return wave comprises a reflected portion of the first ultrasonic transmission wave.

29. The device of claim 27, further comprising means for receiving a piezoelectric transducer control signal, means for receiving the piezoelectric transducer control signal further comprising means for transmitting a first ultrasonic transmission wave through at least one of the plurality of fluids based on the piezoelectric transducer control signal;
wherein at least a portion of the ultrasonic return wave received through at least one of the plurality of fluids comprises a reflected portion of the first ultrasonic transmission wave.

30. The device of claim 29, means for receiving the piezoelectric transducer control signal further comprising means for generating a second wave reception signal based, at least in part, on another reflected portion of the ultrasonic return wave as received through at least one of the plurality of fluids.

31. The device of claim 29, wherein the surface defines a first part of the enclosed region and means for receiving the piezoelectric transducer control signal being disposed on a second surface that defines a second part of the enclosed region that is exclusive to the first part of the enclosed region.

32. The device of claim 27, further comprising:
means for generating a second wave reception signal;
means for determining a first time of flight based on the first wave reception signal and a second time of flight based on the second wave reception signal; and
means for determining the measurement of the tilt of the device based on a comparison of the first time of flight and the second time of flight.

33. The device of claim 32, further comprising means for determining the measurement of the tilt of the device based on a distance between means for generating the first wave reception signal and means for generating the second wave reception signal.

34. The device of claim 32, further comprising:
means for determining a phase difference between a first phase corresponding to the first wave reception signal and a second phase corresponding to the second wave reception signal; and
means for determining the measurement of the tilt of the device based on the phase difference.

35. The device of claim 32, further comprising:
means for selecting a frequency and a transmission timing of a first piezoelectric transducer control signal and a second piezoelectric transducer control signal;
means for selecting a range-gate delay that follows the first piezoelectric transducer control signal and the second piezoelectric transducer control signal; and
means for selecting a range-gate window, wherein the range-gate window follows the range-gate delay, and wherein the first wave reception signal and the second wave reception signal are acquired during the range-gate window.

36. The device of claim 30, further comprising:
means for determining a first amplitude value corresponding to the first wave reception signal;
means for determining a second amplitude value corresponding to the second wave reception signal; and
means for determining the measurement of the tilt of the device based, at least in part, on the first amplitude value and the second amplitude value.

37. The device of claim 36, further comprising:
means for determining a plurality of amplitude values corresponding to a plurality of wave reception signals for at least a subset of a plurality of piezoelectric transducers;
means for identifying a wave reception pattern based, at least in part, on the plurality of amplitude values; and
means for determining the measurement of the tilt of the device based, at least in part, on the wave reception pattern.

38. The device of claim 28, further comprising means for applying a first piezoelectric transducer control signal to means for generating the first wave reception signal and a second piezoelectric transducer control signal to means for generating a second wave reception signal, wherein the second piezoelectric transducer control signal has at least one different signal characteristic than the first piezoelectric transducer control signal.

39. The device of claim 27, further comprising:
means for generating a second wave reception signal;
means for comparing the first wave reception signal and the second wave reception signal to a wave reception signal amplitude threshold;
means for determining a position of a strike area on the surface based, at least in part, on the comparison; and
means for determining the measurement of the tilt of the device based, at least in part, on the position of the strike area on the surface.

40. A non-transitory computer-readable medium comprising at least one instruction for causing a processor to perform operations, the non-transitory computer-readable medium comprising:
code for determining a measurement of a tilt of a device based, at least in part, on a first wave reception signal, the first wave reception signal being based, at least in part, on an ultrasonic return wave received through at least one of a plurality of fluids, and received from a first piezoelectric transducer disposed on a surface at least partially defining an enclosed region, wherein:
the plurality of fluids are within the enclosed region, and
the plurality of fluids comprise at least a first fluid having a first acoustic impedance and a second fluid having a second acoustic impedance different from the first acoustic impedance.

41. The non-transitory computer-readable medium of claim 40, wherein the first piezoelectric transducer from which the first wave reception signal is received is configured to:
receive a first piezoelectric transducer control signal; and
transmit a first ultrasonic transmission wave through at least one of the plurality of fluids based on the first piezoelectric transducer control signal;
wherein at least a portion of the ultrasonic return wave comprises a reflected portion of the first ultrasonic transmission wave.

42. The non-transitory computer-readable medium of claim 40, further comprising:
code for transmitting a piezoelectric transducer control signal to a second piezoelectric transducer, the second piezoelectric transducer being configured to:
receive the piezoelectric transducer control signal; and
transmit a first ultrasonic transmission wave through at least one of the plurality of fluids based on the piezoelectric transducer control signal;
wherein at least a portion of the ultrasonic return wave received through at least one of the plurality of fluids by the first piezoelectric transducer comprises a reflected portion of the first ultrasonic transmission wave.

43. The non-transitory computer-readable medium of claim 42, the second piezoelectric transducer being further configured to generate a second wave reception signal based, at least in part, on another reflected portion of the ultrasonic return wave as received by the second piezoelectric transducer through at least one of the plurality of fluids.

44. The non-transitory computer-readable medium of claim 42, the surface defining a first part of the enclosed region and the second piezoelectric transducer being disposed on a second surface that defines a second part of the enclosed region that is exclusive to the first part of the enclosed region.

45. The non-transitory computer-readable medium of claim 40, further comprising:
code for determining a first time of flight based on the first wave reception signal received from the first piezoelectric transducer and a second time of flight based on a second wave reception signal received from a second piezoelectric transducer; and
code for determining the measurement of the tilt of the device based on a comparison of the first time of flight and the second time of flight.

46. The non-transitory computer-readable medium of claim 45, further comprising code for determining the measurement of the tilt of the device based on a distance between the first piezoelectric transducer and the second piezoelectric transducer.

47. The non-transitory computer-readable medium of claim 45, further comprising:
code for determining a phase difference between a first phase corresponding to the first wave reception signal and a second phase corresponding to the second wave reception signal received from the second piezoelectric transducer; and
code for determining the measurement of the tilt of the device based on the phase difference.

48. The non-transitory computer-readable medium of claim 45, further comprising:
code for selecting a frequency and a transmission timing of a first piezoelectric transducer control signal and a second piezoelectric transducer control signal;
code for selecting a range-gate delay that follows the first piezoelectric transducer control signal and the second piezoelectric transducer control signal; and
code for selecting a range-gate window, wherein the range-gate window follows the range-gate delay, and wherein the first wave reception signal and the second wave reception signal are acquired during the range-gate window.

49. The non-transitory computer-readable medium of claim 43, further comprising:
code for determining a first amplitude value corresponding to the first wave reception signal;
code for determining a second amplitude value corresponding to the second wave reception signal; and
code for determining the measurement of the tilt of the device based, at least in part, on the first amplitude value and the second amplitude value.

50. The non-transitory computer-readable medium of claim 49, further comprising:
code for determining a plurality of amplitude values corresponding to a plurality of wave reception signals for at least a subset of a plurality of piezoelectric transducers;
code for identifying a wave reception pattern based, at least in part, on the plurality of amplitude values; and
code for determining the measurement of the tilt of the device based, at least in part, on the wave reception pattern.

51. The non-transitory computer-readable medium of claim 41, further comprising code for applying a first piezoelectric transducer control signal to the first piezoelectric transducer and a second piezoelectric transducer control signal to a second piezoelectric transducer, wherein the second piezoelectric transducer control signal has at least one different signal characteristic than the first piezoelectric transducer control signal.

52. The non-transitory computer-readable medium of claim 40, further comprising:
code for comparing the first wave reception signal and a second wave reception signal received from a second piezoelectric transducer to a wave reception signal amplitude threshold;
code for determining a position of a strike area on the surface based, at least in part, on the comparison; and
code for determining the measurement of the tilt of the device based, at least in part, on the position of the strike area on the surface.
